(19) United States
(12) Patent Application Publication
(10) Pub. No.: US 2026/0121515 A1
(43) Pub. Date: Apr. 30, 2026

(54) POWER CONVERSION DEVICE AND REFRIGERATION CYCLE APPARATUS

(71) Applicant: Mitsubishi Electric Corporation, Tokyo (JP)

(72) Inventors: Shuta ISHIKAWA, Tokyo (JP); Toshiki ASAI, Tokyo (JP)

(73) Assignee: Mitsubishi Electric Corporation, Tokyo (JP)

(21) Appl. No.: 19/308,420

(22) Filed: Aug. 25, 2025

(30) Foreign Application Priority Data
Oct. 31, 2024 (JP) 2024-191462

(51) Int. Cl. H02M 1/14; H02M 1/08; H02M 3/157; H02M 3/158

(52) U.S. Cl. CPC H02M 1/143; H02M 1/082; H02M 3/157; H02M 3/1582

(57) ABSTRACT

The power conversion device includes a rectifier circuit to convert an input voltage of a three-phase AC input from AC input terminals into a DC voltage, a converter to output an output voltage set to a set voltage value from the DC voltage, a smoothing capacitor connected between an output terminal and an output terminal of the converter, a filter disposed between the AC input terminals and the converter and including a filter capacitor, and a controller to control the converter. The converter is controlled with PWM by a control signal based on a command. The controller generates a command for reducing a difference between a detection value and a target value in a filter focusing target that is any one of a voltage, a current, a voltage ripple component, and a current ripple component of the filter.

### CROSS-REFERENCE TO RELATED APPLICATION

The present application claims the benefit of priority to Japanese Patent Application No. 2024-191462, filed Oct. 31, 2024, which is incorporated herein by reference in its entirety.

### BACKGROUND OF THE INVENTION

### 1. Field of the Invention

The present disclosure relates to a power conversion device and a refrigeration cycle apparatus.

### 2. Description of the Background Art

Patent Document 1 discloses a step-down chopper device that receives a three-phase AC as an input, converts the input current into a DC voltage via a rectifier, and steps down the converted voltage by switching a semiconductor switch. The step-down chopper device includes a smoothing capacitor on the output side, and a current on which a carrier ripple current is superimposed is generated due to the influence of the switching of the semiconductor switch. Therefore, if the carrier ripple current is allowed to flow out as it is, there is a possibility that peripheral devices are to be broken.

In view of this, the step-down chopper device of Patent Document 1 is provided with a capacitor (filter capacitor) for removing the carrier ripple current between a step-down converter and the rectifier. The step-down converter being configured by a semiconductor switch, a diode, and a reactor. The carrier ripple current generated in the step-down converter is absorbed by the capacitor disposed on the input side of the step-down converter, thereby reducing the carrier ripple current flowing out to the peripheral devices of the step-down chopper device.

Furthermore, the step-down chopper device of Patent Document 1 compares a modulated triangular wave S4 generated on the basis of a voltage Vi of the filter capacitor with an output signal S1 based on an output voltage Vo of the smoothing capacitor, thereby generating a pulse width modulation (PWM) signal S5 based on the comparison result to control the semiconductor switch. That is, the step-down chopper device of Patent Document 1 performs feedback control of the output voltage Vo on the basis of the output voltage Vo being the voltage of the smoothing capacitor, and the voltage Vi of the filter capacitor. In addition, by reducing the ripple of the output voltage Vo, the step-down chopper device of Patent Document 1 can reduce the electrostatic capacitance of the filter capacitor on the input side of the step-down converter.
Patent Document 1: Japanese Patent Application Laid-Open No. 2000-312478
Patent Document 2: International Publication No. WO2023/073870

Patent Document 2 discloses that if the electrostatic capacitance of a filter capacitor, which is a capacitor disposed between a rectifier and a power conversion unit that converts DC power into AC power, is made too large, an input current to the filter capacitor and a charging/discharging current of the filter capacitor have a shape resembling “rabbit ears”, that is, a spike shape. This spike shaped current flows out of the rectifier to the power supply, causing the power supply current to have a spike shape. That is, the power supply current is greatly distorted, and the power supply harmonics are deteriorated.

### SUMMARY OF THE INVENTION

The present disclosure aims to reduce a carrier ripple current and to reduce an outflow of the carrier ripple current to a power supply.

A power conversion device includes a rectifier circuit to convert an input voltage of a three-phase AC input from AC input terminals into a DC voltage, a converter to output an output voltage set to a set voltage value from the DC voltage output from the rectifier circuit, a smoothing capacitor connected between a positive-side converter output terminal and a negative-side converter output terminal of the converter from which the output voltage is output, a filter disposed between the AC input terminals and the converter and including a filter capacitor, and a controller to control the converter. The converter includes a switching element that is controlled with PWM by a control signal generated on the basis of a carrier wave and an on-duty command. The controller designates any one of a voltage of the filter, a current of the filter, a ripple component in the voltage of the filter, and a ripple component in the current of the filter as a filter focusing target, and generates the on-duty command for reducing a difference between a detection value of the filter focusing target and a target value of the filter focusing target.

In the power conversion device of the present disclosure, since the filter having the filter capacitor is disposed between the AC input terminals and the converter, and the controller generates the on-duty command for reducing the difference between the detection value and the target value in the filter focusing target that is any one of the voltage of the filter, the current of the filter, a ripple component in the voltage of the filter, and a ripple component in the current of the filter, it is possible to reduce the carrier ripple current and to reduce the outflow of the carrier ripple current to the power supply.

### BRIEF DESCRIPTION OF THE DRAWINGS

FIG. 1 is a diagram showing a configuration of a power conversion device according to Embodiment 1.

FIG. 2 is a diagram showing a configuration of a first controller according to Embodiment 1.

FIG. 3 is a diagram for describing a duty ratio.

FIG. 4 is a diagram showing a configuration of a rectifier circuit of FIG. 1.

FIG. 5 is a diagram showing a configuration of a second controller according to Embodiment 1.

FIG. 6 is a diagram showing a configuration of a phase change feedback control unit of FIG. 5.

FIG. 7 is a diagram showing a configuration of a third controller according to Embodiment 1.

FIG. 8 is a diagram showing a configuration of a fourth controller according to Embodiment 1.

FIG. 9 is a diagram showing a configuration of a fifth controller according to Embodiment 1.

FIG. 10 is a diagram showing an operation waveform of a power conversion device of a comparative example.

FIG. 11 is a diagram showing an operation waveform of the power conversion device according to Embodiment 1.

FIG. 12 is a diagram showing an operation waveform of the power conversion device according to Embodiment 1.

FIG. 13 is a diagram showing a configuration of a power conversion device according to Embodiment 2.

FIG. 14 is a diagram showing a configuration of another example of a converter of FIG. 13.

FIG. 15 is a diagram showing a configuration of a first power conversion device according to Embodiment 3.

FIG. 16 is a diagram showing a configuration of a second power conversion device according to Embodiment 3.

FIG. 17 is a diagram showing a configuration of a power conversion device according to Embodiment 4.

FIG. 18 is a diagram showing a configuration of a first controller according to Embodiment 4.

FIG. 19 is a diagram showing a configuration of a second controller according to Embodiment 4.

FIG. 20 is a diagram showing a configuration of a first refrigeration cycle apparatus according to Embodiment 5.

FIG. 21 is a diagram showing a configuration of a refrigerant circuit of FIG. 20.

FIG. 22 is a diagram showing a configuration of an inverter of FIG. 20.

FIG. 23 is a diagram showing a configuration of a second refrigeration cycle apparatus according to Embodiment 5.

FIG. 24 is a diagram showing an example of a hardware configuration for implementing a function of a controller by digital calculation.

### DETAILED DESCRIPTION OF THE EMBODIMENTS OF THE INVENTION

### Embodiment 1

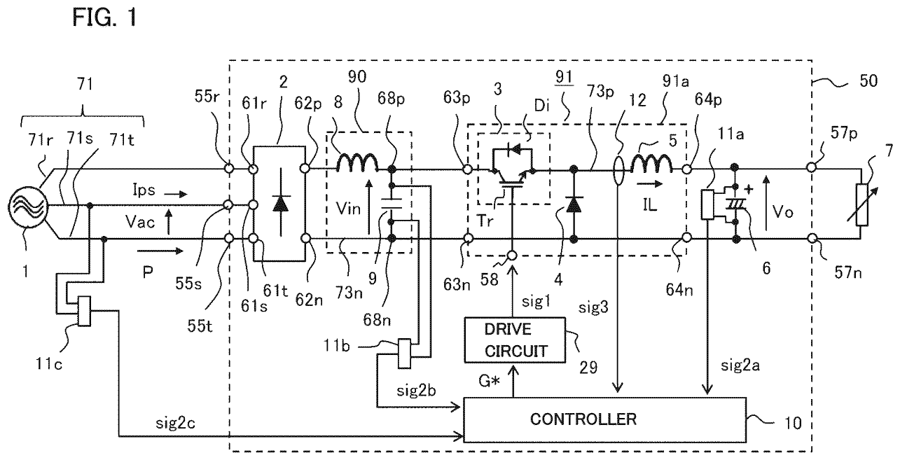

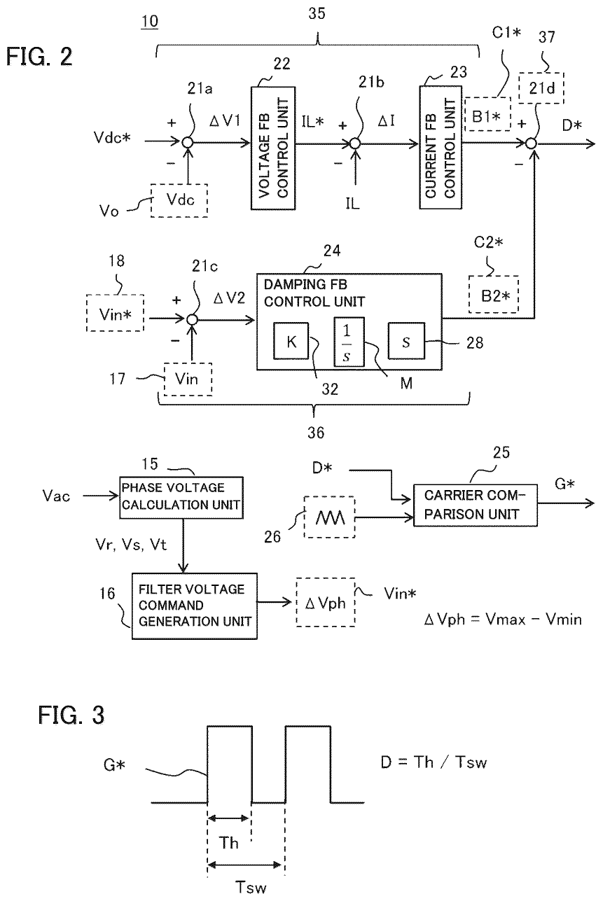

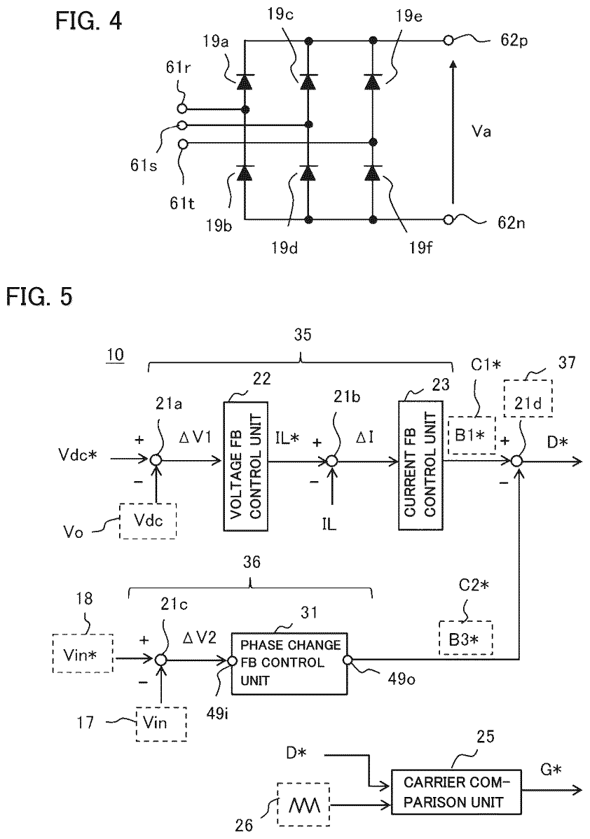

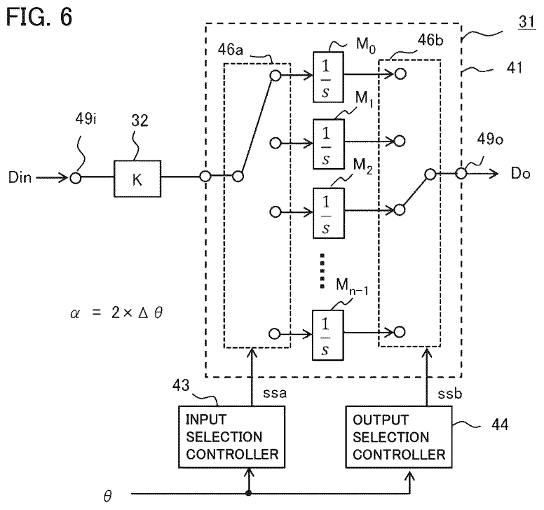

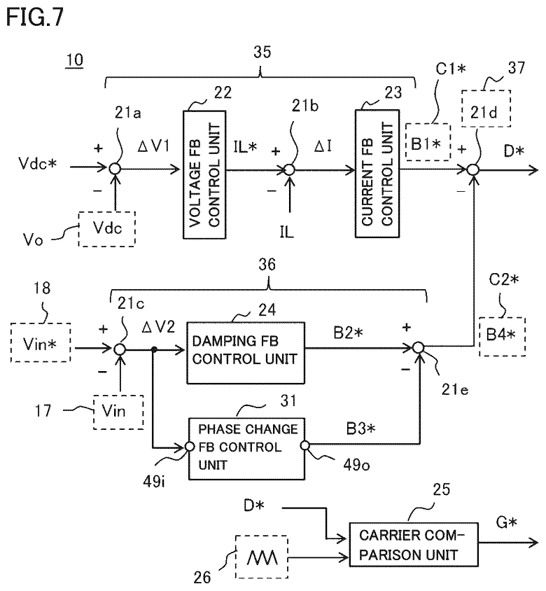

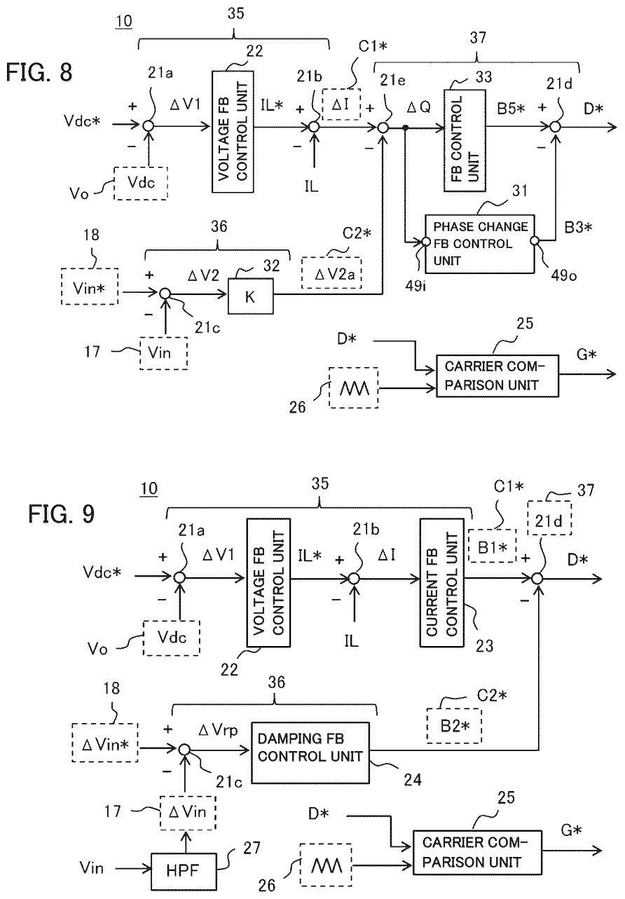

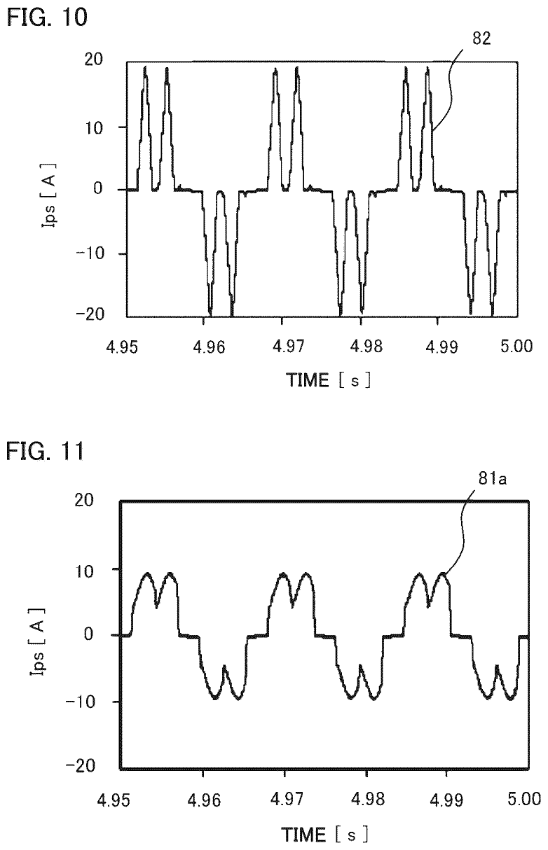

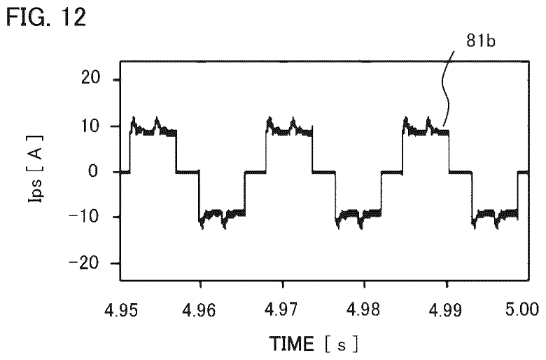

FIG. 1 is a diagram showing a configuration of a power conversion device according to Embodiment 1, and FIG. 2 is a diagram showing a configuration of a first controller according to Embodiment 1. FIG. 3 is a diagram showing a duty ratio, and FIG. 4 is a diagram showing a configuration of a rectifier circuit of FIG. 1. FIG. 5 is a diagram showing a configuration of a second controller according to Embodiment 1, and FIG. 6 is a diagram showing a configuration of a phase change feedback control unit of FIG. 5. FIG. 7 is a diagram showing a configuration of a third controller according to Embodiment 1, FIG. 8 is a diagram showing a configuration of a fourth controller according to Embodiment 1, and FIG. 9 is a diagram showing a configuration of a fifth controller according to Embodiment 1. FIG. 10 is a diagram showing an operation waveform of a power conversion device of a comparative example. Each of FIG. 11 and FIG. 12 is a diagram showing an operation waveform of the power conversion device according to Embodiment 1. The power conversion device 50 according to Embodiment 1 converts three-phase AC input power input from a three-phase AC power supply 1 into DC power and supplies the DC power to a load 7.

The power conversion device 50 includes a rectifier circuit 2 for converting input power, i.e., an input voltage and an input current, of the three-phase AC power supply 1 from AC input terminals 55r, 55s, and 55t, to DC power i.e., a DC voltage and a DC current, a converter 91 for outputting an output voltage Vo set to a set voltage value, from the DC voltage output from the rectifier circuit 2, a smoothing capacitor 6 connected between a positive-side output terminal 64p (positive-side converter output terminal) and a negative-side output terminal 64n (negative-side converter output terminal) in the converter 91 from which the output voltage Vo is output, and a controller 10 for controlling the converter 91, and supplies to the load 7 DC power having the output voltage Vo set to the set voltage value from output terminals 57p and 57n.

The converter 91 includes a switching element 3, a diode 4, and a control reactor 5. In Embodiment 1, a step-down converter 91a will be described as an example of the converter 91. In Embodiment 2, a step-up converter 91b and a step-up/step-down converter 91c will be described as examples of the converter 91. The smoothing capacitor 6 is connected between the positive-side DC output terminal 64p and the negative-side DC output terminal 64n of the step-down converter 91a, and the smoothing capacitor 6 stabilizes the output voltage Vo. The DC power having the output voltage Vo is supplied to the load 7. As the switching element 3, for example, a power semiconductor element such as an insulated gate bipolar transistor (IGBT), a metal-oxide-semiconductor field-effect transistor (MOSFET), or the like is used. In FIG. 1, an example of an IGBT is shown. The switching element 3 includes a transistor Tr being the IGBT, and a diode Di. The diode Di is connected in anti-parallel to the transistor Tr being the IGBT. When a MOSFET is used as the transistor Tr of the switching element 3, the collector and emitter of the IGBT are interpreted as the drain and source of the MOSFET.

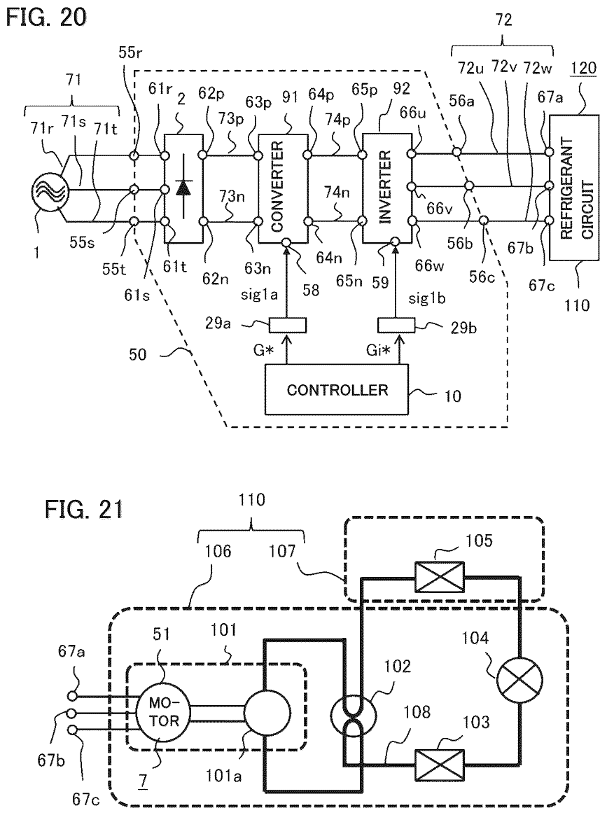

In FIG. 1, a DC variable resistor is shown as an example of the load 7. The load 7 is not limited to the DC variable resistor, and may be, for example, a constant current load or a constant power load. Alternatively, a motor (refer to FIG. 21) may be connected after the power is inversely converted to AC power by using an inverter (refer to FIG. 20). In this case, the combination of the inverter and the motor can be regarded as a DC variable resistor.

A filter 90 including a filter capacitor 9 is disposed between the three-phase AC power supply 1 and DC input terminals 63p and 63n of the converter 91. More specifically, the filter 90 is disposed between the three-phase AC power supply 1 and the switching element 3 of the converter 91. That is, the power conversion device 50 includes the filter 90 between the AC input terminals 55r, 55s, and 55t, and the switching element 3. Here, a filter reactor 8 is disposed right after the rectifier circuit 2, and a filter capacitor 9 is disposed in the subsequent stage. The filter 90 serves to reduce a carrier ripple current generated in the converter 91 such as the step-down converter 91a and to reduce an outflow of the carrier ripple current to the power supply. The role of the filter 90 can also be described as follows. The filter 90 serves to reduce distortion of a power supply current Ips due to the carrier ripple current generated in the converter 91 such as the step-down converter 91a and to reduce current distortion of the power supply current Ips having a shape resembling “rabbit ears”, that is, a spike shape. Although an example in which the filter 90 includes the filter reactor 8 will be described in Embodiment 1, the filter 90 may not include the filter reactor 8.

The controller 10 designates any one of a voltage of the filter 90, a current of the filter 90, a ripple component in the voltage of the filter 90, or a ripple component in the current of the filter 90 as a filter focusing target 17, and generates an on-duty command D* that reduces the difference between a detection value of the filter focusing target 17 and a command value of a filter focusing target command 18, which is a target value of the filter focusing target 17. The on-duty command D* is a command that reduces the difference between the detection value of the filter focusing target 17 and the command value of the filter focusing target command 18, which is the target value of the filter focusing target 17, and is generated so as to reduce the difference between the detection value of the filter focusing target 17 and the command value of the filter focusing target command 18, which is the target value of the filter focusing target 17. The on-duty command D* is a command used to generate a control signal sig1 for PWM control of the switching element 3. When the on-duty command D* is updated multiple times, the difference between the detection value of the filter focusing target 17 and the command value of the filter focusing target command 18, which is the target value of the filter focusing target 17, becomes smaller than that at the time of starting the control or at the time of changing an operating condition to be close to zero. In Embodiment 1, an example in which the filter focusing target 17 is the voltage of the filter 90 and the filter focusing target command 18 is a command of the voltage of the filter 90, and an example in which the filter focusing target 17 is the ripple component in the voltage of the filter 90 and the filter focusing target command 18 is a command of the ripple component in the voltage of the filter 90 will be described. An example in which the filter focusing target 17 is the current of the filter 90 and the filter focusing target command 18 is a command of the current of the filter 90, and an example in which the filter focusing target 17 is the ripple component in the current of the filter 90 and the filter focusing target command 18 is a command of the ripple component in the current of the filter 90 will be described in Embodiment 4.

The power conversion device 50 of Embodiment 1 will be described in detail. The rectifier circuit 2 is a bridge rectifier circuit including, for example, six diodes 19a to 19f. Diodes 19a and 19b connected in series are for an arm of an r-phase of the three-phase AC, diodes 19c and 19d connected in series are for an arm of an s-phase of the three-phase AC, and diodes 19e and 19f connected in series are for an arm of a t-phase of the three-phase AC. An AC input terminal 61r is connected to a connection point of the diodes 19a and 19b, an AC input terminal 61s is connected to a connection point of the diodes 19c and 19d, and an AC input terminal 61t is connected to a connection point of the diodes 19e and 19f. Cathodes of the diodes 19a, 19c, and 19e are connected to a positive-side DC output terminal 62p, and anodes of the diodes 19b, 19d, and 19f are connected to a negative-side DC output terminal 62n. The rectifier circuit 2 outputs a DC output voltage Va from the DC output terminals 62p and 62n. The three-phase AC power supply 1 is connected to the AC input terminals 55r, 55s, and 55t of the power conversion device 50 through power lines 71r, 71s, and 71t. The reference signs for the power lines connected to the AC input terminals 55r, 55s, and 55t are collectively denoted by a reference numeral 71, and 71r, 71s, and 71t are used for distinction.

The AC input terminals 61r, 61s, and 61t of the rectifier circuit 2 are connected to the AC input terminals 55r, 55s, and 55t of the power conversion device 50, respectively. Input power P, that is, an interphase voltage Vac and the power supply current Ips of each phase are input from the three-phase AC power supply 1 to the AC input terminals 61r, 61s, and 61t of the rectifier circuit 2 via the power lines 71 and the AC input terminals 55r, 55s, and 55t. The interphase voltage Vac and the power supply current Ips are an input voltage and an input current, respectively, which are input to the rectifier circuit 2 of the power conversion device 50. The interphase voltage Vac is a voltage between two phases of the three-phase AC input from the AC input terminals 55r, 55s, and 55t. The interphase voltage Vac is generally referred to as a line-to-line voltage among power lines 71 of the three-phase AC power supply 1. The rectifier circuit 2 converts the input power P, that is, an input voltage (interphase voltage Vac) and an input current (power supply current Ips) of the three-phase AC power supply 1 input from the AC input terminals 55r, 55s, and 55t into DC power, that is, a DC voltage (output voltage Va) and a DC current. FIG. 1 shows the interphase voltage Vac between the s-phase and the t-phase. There are also interphase voltages Vac between the r-phase and the s-phase and between the r-phase and the t-phase.

The filter 90, the converter 91, and the smoothing capacitor 6 are sequentially arranged on the downstream side of the rectifier circuit 2, and the output voltage Vo of the smoothing capacitor 6 is output from the output terminals 57p and 57n of the power conversion device 50 to the load 7. The DC output terminal 62p of the rectifier circuit 2 is connected to the output terminal 57p of the power conversion device 50 by a positive-side line 73p in which the filter reactor 8 of the filter 90, and the switching element 3 and the control reactor 5 that are in the converter 91 are inserted. The DC output terminal 62n of the rectifier circuit 2 is connected to the output terminal 57n of the power conversion device 50 by a negative-side line 73n.

The filter 90 includes the filter reactor 8 and the filter capacitor 9, and is disposed between the AC input terminals 55r, 55s, and 55t, and the converter 91 of the power conversion device 50. FIG. 1 shows an example in which the filter 90 is disposed downstream of the rectifier circuit 2 connected to the AC input terminals 55r, 55s, and 55t. The filter reactor 8 of the filter 90 shown in FIG. 1 is disposed closer to the AC input terminals 55r, 55s, and 55t than the filter capacitor 9, and is connected between the DC output terminal 62p and a positive-side capacitor terminal 68p, the DC output terminal 62p being a positive-side rectifier circuit output terminal of the rectifier circuit 2, the positive-side capacitor terminal 68p being one end of the filter capacitor 9 connected to the DC input terminal 63p being the positive-side converter input terminal of the converter 91. More specifically, one end of the filter reactor 8 is connected to the DC output terminal 62p of the rectifier circuit, and the other end of the filter reactor 8 is connected by the positive-side line 73p to the positive-side capacitor terminal 68p being one end of the filter capacitor 9, and the DC input terminal 63p of the converter 91. A negative-side capacitor terminal 68n being the other end of the filter capacitor 9 is connected to the negative-side line 73n.

The converter 91 includes the DC input terminals 63p and 63n, the DC output terminals 64p and 64n, and a control terminal 58. In the step-down converter 91a, which is an example of the converter 91, the collector of the switching element 3 is connected to the DC input terminal 63p, and the emitter of the switching element 3 is connected to the cathode of the diode 4 and one end of the control reactor 5. The other end of the control reactor 5 is connected to the DC output terminal 64p. The anode of the diode 4 is connected to the negative-side line 73n, and is connected to the DC input terminal 63n and the DC output terminal 64n by the negative-side line 73n. The gate of the switching element 3 is connected to the control terminal 58. A control signal sig1, whose voltage value is changed by a drive circuit 29 on the basis of a gate signal command G* output from the controller 10, is input to the control terminal 58. The control signal sig1 is a signal for controlling an ON state and an OFF state of the switching element 3 by, for example, PWM control.

The controller 10 controls a control reactor current IL, which is a current of the control reactor 5 of the step-down converter 91a, and/or the output voltage Vo as aimed. Information of each of sensors to be detected by the power conversion device 50 is input to the controller 10. In this case, voltages detected by the voltage sensor 11a to 11c is input to the controller 10 as voltage sensor information sig2a to sig2c. The volage sensor information sig2a is a voltage of the smoothing capacitor 6 detected by the voltage sensor 11a, the volage sensor information sig2b is a voltage of the filter capacitor 9 detected by the voltage sensor 11b, and the volage sensor information sig2c is the interphase voltage Vac detected by the voltage sensor 11c. The control reactor current IL being the current of the control reactor 5 detected by a current sensor 12 is input to the controller 10 as current sensor information sig3. The current sensor 12 for detecting the control reactor current IL of the control reactor 5 is disposed on the input side of the control reactor 5, that is, on the side of the DC input terminal 63p of the converter 91 with respect to the control reactor 5. More specifically, the current sensor 12 is disposed between the emitter of the switching element 3 and the cathode of the diode 4, and one end of the control reactor 5. When the feedback control by the controller 10, which will be described later, is performed on a filter capacitor voltage Vin being the voltage of the filter capacitor 9, ripple of the power supply current Ips can be reduced.

The control signal sig1 is an operation signal for operating the switching element 3 in a predetermined state. In general, the control signal sig1 corresponds to the ON/OFF signal for controlling the switching element 3 to be in the ON state or the OFF state. Here, the signal is input to the switching element 3 via the drive circuit 29 for operating the switching element 3.

In order to control the step-down converter 91a, voltage information of the smoothing capacitor 6 and current information of the control reactor 5 are required. Here, the voltage information and the current information required for controlling the step-down converter 91a are the voltage sensor information sig2a of the smoothing capacitor 6 and the current sensor information sig3 of the control reactor 5 that are to be detected by using the voltage sensor 11a and the current sensor 12. However, the voltage information of the smoothing capacitor 6 and the current information of the control reactor 5 are not necessarily detected by using the voltage sensor 11a and the current sensor 12, and estimated values may be used instead.

Configurations of the first to fifth controllers 10 are shown in FIG. 2, FIG. 5, FIG. 7, FIG. 8, and FIG. 9. The first to fifth controllers 10 determine a smoothing capacitor voltage command Vdc*, which is a voltage command for controlling the output voltage Vo being the voltage of the smoothing capacitor 6, to an arbitrary value. The output voltage Vo being the voltage of the smoothing capacitor 6 is denoted as a smoothing capacitor voltage Vdc, as appropriate.

The first to fifth controllers 10 obtain a voltage deviation ΔV1, which is a deviation between a command value of the smoothing capacitor voltage command Vdc* of the smoothing capacitor 6 and a detection value of the smoothing capacitor voltage Vdc, which is a detection value of the output voltage Vo of the smoothing capacitor 6, by a subtractor 21a. The voltage deviation AVI is input to a voltage feedback control unit 22 that performs voltage feedback control. The voltage feedback control is often performed by using proportional-integral control (PI control). The voltage feedback control may be performed by using proportional-integral-derivative control (PID control), proportional-derivative control (PD control), or the like, or may be performed by using another combination of proportional control (P control), integral control (I control), and derivative control (D control). The P control for outputting output data that multiplies the input data by K times is performed by a proportional output unit 32. The I control for outputting output data that integrates input data is performed by an integrator M. The D control for outputting output data that differentiates input data is performed by a differentiator 28. Note that, in the figures, “feedback” of the voltage feedback control unit and the current feedback control unit is denoted as “FB”.

In Embodiment 1, since the converter 91 is the step-down converter 91a, the smoothing capacitor voltage command Vdc* needs to be set to be smaller than the voltage of the filter capacitor 9 input to the step-down converter 91a, that is, the filter capacitor voltage Vin. When the smoothing capacitor voltage command Vdc* is set to be larger than the voltage of the filter capacitor 9, the switching element 3 is always in the ON state, resulting in the same as the normal rectifying operation, and the output voltage from the step-down converter 91a is the same as the voltage input thereto, and cannot be stepped up to the set voltage of the smoothing capacitor voltage command Vdc*.

An output of the voltage feedback control unit 22 is output as a current command IL* for the control reactor 5. A current deviation AI, which is a deviation between a command value of the current command IL* for the control reactor 5 and a detection value of the control reactor current IL of the control reactor 5, is obtained by a subtractor 21b in a subsequent stage of the voltage feedback control unit 22. The current deviation AI is directly input to a current feedback control unit 23 that performs current feedback control. In the first, second, third, and fifth controllers 10, the current deviation AI is directly input to the current feedback control unit 23. In the fourth controller 10, the current deviation AI is indirectly input to a feedback control unit 33 that has the function of the current feedback control unit 23. The current feedback control often uses the PI control. The current feedback control may use the PID control, the PD control, or the like similarly to the voltage feedback control, and may use another combination of the P control, the I control, and the D control. In the first, second, third, and fifth controllers 10, the output of the current feedback control unit 23 is output as a first command B1* input to a subtractor 21d that generates the on-duty command D*. In the fourth controller 10, the output of the feedback control unit 33 having the function of the current feedback control unit 23 is output as a fifth command B5* input to the subtractor 21d that generates the on-duty command D* The current feedback control of the current feedback control unit 23 in the first, second, third, and fifth controllers 10 and the current feedback control of the feedback control unit 33 in the fourth controller 10 are for making the power supply current Ips of the three-phase AC power supply 1 in a rectangular wave shape, that is, a rectangular wave current. The current feedback control by the current feedback control unit 23 and the feedback control unit 33 need to be designed to be as highly responsive as possible in order to make the power supply current Ips have a rectangular wave shape. As for the current control, it is possible to perform the control with higher accuracy by using repetitive control.

In order to reduce the ripple of the power supply current Ips, a damping feedback control unit 24 and a phase change feedback control unit 31 are added in the first to fifth controllers 10. First, the first controller 10 will be described. In the first controller 10, the damping feedback control unit 24 is added to reduce the ripple of the power supply current Ips. A voltage deviation AV2 that is a deviation between a command value of a filter capacitor voltage command Vin* being a voltage command of the filter capacitor 9 and a detection value of the filter capacitor voltage Vin of the filter capacitor 9 is obtained by a subtractor 21c. The voltage deviation AV2 is input to the damping feedback control unit 24 for reducing the ripple. In the feedback control for reducing the ripple, the PI control is often used as in the voltage feedback control and current feedback control. In the feedback control for reducing the ripple, the PID control, the PD control, or the like may be used, and another combination of the P control, the I control, and the D control may be possible, as in the voltage feedback control and current feedback control. Note that, in the damping feedback control unit 24 of FIG. 2, an example is shown in which the proportional output unit 32, the integrator M, and the differentiator 28 are included. Further, in the figures, “feedback” of the damping feedback control unit, the phase change feedback control unit, and the feedback control unit is denoted as “FB”

Here, a method of generating the filter capacitor voltage command Vin* of the filter capacitor 9 will be described. Phase voltages Vr, Vs, and Vt having an amplitude Vam and a power supply phase θ are calculated by a phase voltage calculation unit 15 from analog voltage signals of the interphase voltage Vac of the three-phase AC power supply 1. As a calculation method, a method called an enhanced Phase Looked Loop (ePLL) can be used.

The amplitude Vam and the power supply phase θ may be derived using a zero crossing signal of the interphase voltage Vac. When only the zero crossing from the negative signal to the positive signal is detected in the interphase voltage Vac, the zero crossing signal is input to the phase voltage calculation unit 15 once in one cycle of the three-phase AC. When the time between the zero crossings is a time T1 and the current time from the immediately preceding zero crossing is a time T2, the power supply phase θ being a phase angle can be calculated as in Equation (1). The unit shall be radians [rad].

$$θ = ( T 1 / T 2 ) \times 2 π \qquad ( 1 )$$

The amplitude Vam can be calculated as in Equation (2) by integrating the absolute value of the interphase voltage Vac between the zero crossings and taking the average value.

$${V}_{a m} = \frac{π}{2} \frac{1}{T 1} {\int }_{0}^{T 1} \vert {V}_{a c} \vert dt \qquad ( 2 )$$

π/2 is the coefficient for converting from the average to the root mean square value. Thus, by using Equation (1) and Equation (2) from the zero crossings, the amplitude Vam for the phase voltages Vr, Vs, and Vt and the power supply phase θ can be derived.

The amplitude Vam of the phase voltages Vr, Vs, and Vt and the power supply phase θ can be calculated using only the zero crossing signal, without analog detection of the interphase voltage Vac. In this case, the amplitude Vam for the phase voltages Vr, Vs, and Vt can be derived using an average value of the voltage of the filter capacitor 9, Vinave, by Equation (3).

$$Vam = K 1 \times Vinave \qquad ( 3 )$$

K1 is a gain and should be typically set to “K1=π/3.” When a resistive component in a power supply impedance etc. of the three-phase AC power supply 1 is large, K1 should be finely adjusted, for example, slightly increased.

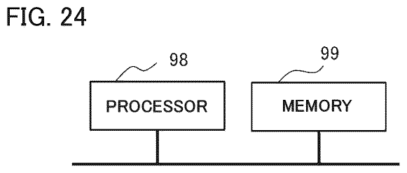

The phase voltages Vr, Vs, and Vt including the calculated amplitude Vam and the power supply phase θ are stored in a memory (refer to FIG. 24) according to Equation (4) to Equation (6).

$$Vs = ( Vam / √ 6 ) \times sin ( θ - π / 6 ) \qquad ( 4 )$$

$$Vs = ( Vam / √ 6 ) \times sin ( θ + 3 π / 6 ) \qquad ( 5 )$$

$$Vt = ( Vam / √ 6 ) \times sin ( θ - 5 π / 6 ) \qquad ( 6 )$$

From the phase voltages Vr, Vs, and Vt stored in the memory, one command value for the filter capacitor voltage command Vin* can be generated by using a maximum phase voltage Vmax and a minimum phase voltage Vmin as shown in Equation (7).

$${Vin}^{*} = V max - V min \qquad ( 7 )$$

The maximum phase voltage Vmax is a maximum phase voltage among the phase voltages Vr, Vs, and Vt. When expressed by a MAX function for obtaining a maximum value, the maximum phase voltage Vmax is MAX (Vr, Vs, Vt). The minimum phase voltage Vmin is a minimum phase voltage among the phase voltages Vr, Vs, and Vt. When expressed by a MIN function for obtaining a minimum value, the minimum phase voltage Vmin is MIN (Vr, Vs, Vt).

At a time when the controller 10 generates each command value of the filter capacitor voltage command Vin*, the phase voltage calculation unit 15 calculates the phase voltages Vr, Vs, and Vt of the three phases of the three-phase AC from the input interphase voltage Vac. Vmax-Vmin is a phase voltage deviation ΔVph obtained by subtracting the minimum phase voltage Vmin from the maximum phase voltage Vmax. The sign of the phase voltage deviation ΔVph is positive or negative because the sign of the maximum phase voltage Vmax and the minimum phase voltage Vmin is positive or negative. At the time when the controller 10 generates each command value of the filter capacitor voltage command Vin*, the filter voltage command generation unit 16 calculates the maximum phase voltage Vmax and the minimum phase voltage Vmin from the values of the phase voltages Vr, Vs, and Vt that are input, and generates the phase voltage deviation ΔVph that is calculated by subtracting the minimum phase voltage Vmin from the maximum phase voltage Vmax, as the filter capacitor voltage command Vin*.

When a DC component of the filter capacitor voltage Vin of the filter capacitor 9 remains in the damping feedback control unit 24 itself, that is, when the DC component of the filter capacitor voltage Vin remains in the voltage deviation AV2, there will be a case where the damping feedback control unit 24 cannot generate an appropriate second command B2*. In this case, the voltage deviation AV2 should be input to the damping feedback control unit 24 via a high-pass filter. Further, the fifth controller 10 shown in FIG. 9 may be configured by extracting a voltage ripple component ΔVin being a ripple component of the filter capacitor voltage Vin from the filter capacitor voltage Vin of the filter capacitor 9 via the high-pass filter 27. In the fifth controller 10, the voltage ripple component ΔVin being the ripple component of the filter capacitor voltage Vin is extracted from the filter capacitor voltage Vin of the filter capacitor 9 via the high-pass filter 27, and a ripple component deviation ΔVrp that is a deviation between a command value of a voltage ripple component command ΔVin* and the voltage ripple component ΔVin is obtained using the subtractor 21c, the voltage ripple component command ΔVin* being a command of the ripple component of the filter capacitor voltage Vin in the filter capacitor 9. The ripple component deviation ΔVrp is input to the damping feedback control unit 24 for reducing the ripple.

The controller 10 generates the on-duty command D* by subtracting the second command B2* generated by the damping feedback control unit 24 from the first command B1* generated by the current feedback control unit 23 with the subtractor 21d. The first command B1* is a command that reduces the difference between the detection value of the smoothing capacitor voltage Vdc, which is the voltage of the smoothing capacitor 6, and the command value of the smoothing capacitor voltage command Vdc*, which is the target value of the voltage of the smoothing capacitor 6. The second command B2* is a command that reduces the difference between the detection value of the filter focusing target 17 and the target value of the filter focusing target 17. The on-duty command D* is generated from each of outputs of two systems, that is, a first system control unit 35 that generates the first command B1*, and a second system control unit 36 that generates the second command B2*. Therefore, the subtractor 21d that generates the on-duty command D* can be described as an on-duty command generation unit 37. The first command B1* can be described as a first system command C1*, and the second command B2* can be described as a second system command C2*. In the first controller 10 shown in FIG. 2, the first system control unit 35 that generates the first command B1*, that is, the first system command C1* includes the subtractor 21a, the voltage feedback control unit 22, the subtractor 21b, and the current feedback control unit 23. The second system control unit 36 that generates the second command B2*, that is, the second system command C2* includes the subtractor 21c and the damping feedback control unit 24.

The controller 10 inputs the on-duty command D* and a carrier wave 26 to a carrier comparison unit 25. As the carrier wave 26, a triangular wave from 5 kHz to 20 kHz is often used. Although FIG. 2 shows an example in which the carrier wave 26 is a triangular wave, the carrier wave 26 may be a sawtooth wave.

The carrier comparison unit 25 compares the on-duty command D* with the carrier wave 26, and when the on-duty command D* is larger than the carrier wave 26, the carrier comparison unit 25 outputs a gate signal command G* for turning the switching element 3 in the ON state. Conversely, when the on-duty command D* is smaller than the carrier wave 26, the carrier comparison unit 25 outputs the gate signal command G* for turning the switching element 3 in the OFF state. The gate signal command G* is a command having a duty ratio D as shown in FIG. 3. The gate signal command G* is typically generated using a PWM function installed on a microcomputer, or generated by a field-programmable gate array (FPGA), an application specific integrated circuit (ASIC), or the like.

The duty ratio D will be described. A pulse wave of the gate signal command G* as a digital signal is shown in FIG. 3. The duty ratio D is obtained by dividing a high period Th, which is a period during which the gate signal command G* is a high voltage (digital value of 1), by a switching period Tsw of the gate signal command G*. That is, the duty ratio Dis expressed by Th/Tsw. The duty ratio D of the control signal sig1, which is a digital signal with the changed voltage value, is similarly expressed in Th/Tsw. The switching period Tsw is the period of the carrier wave 26.

When the switching element 3 is driven by the control signal sig1 based on the gate signal command G* output from the controller 10, the step-down converter 91a can be controlled so as to output a desired voltage value.

The control block diagram of the first controller 10 shown in FIG. 2 is an example of a control method for controlling the converter 91, and this control method does not necessarily need to be used, and the voltage control system, that is, the voltage feedback control unit 22, may be omitted, or the current control system, that is, the current feedback control unit 23, may be omitted.

Next, the second to fifth controllers 10 will be described. The second to fifth controllers 10 are improved versions of the first controller 10. Note that, in FIG. 5, FIG. 7, FIG. 8, and FIG. 9, the phase voltage calculation unit 15 and the filter voltage command generation unit 16 described in FIG. 2 are omitted. The second controller 10 shown in FIG. 5 differs from the first controller 10 in that the damping feedback control unit 24 is replaced with the phase change feedback control unit 31. Components that differ from those in the first controller 10 will be mainly described. FIG. 6 shows a configuration of the phase change feedback control unit 31. The phase change feedback control unit 31 includes a data input terminal 49i, a data output terminal 490, the proportional output unit 32, a memory unit 41, an input selection controller 43, and an output selection controller 44. The second controller 10, in the second system control unit 36, includes the phase change feedback control unit 31 that performs proportional processing and integral processing on an input data Din input from a first terminal, which is the data input terminal 49i, and outputs an output data Do whose phase is changed by a predetermined set phase a, from the second terminal, which is the data output terminal 490. When a frequency for controlling the converter 91 is defined as a control frequency Fct and a number obtained by dividing the control frequency Fct by a power supply frequency Fps being a frequency of the three-phase AC is defined as a division number Ndv, the phase change feedback control unit 31 includes the same number of integrators M as the division number Ndv, a selector 46a that selects an integrator M to which data (input data Din) is input, a selector 46b that selects an integrator M that outputs data (output data Do) that is different in phase from the input data Din by the set phase a, and the proportional output unit 32 in a data path between the first terminal (data input terminal 49i) and the second terminal (data output terminal 490).

The memory unit 41 has a total of N integrators M corresponding to the power supply phases θ. Specifically, the memory unit 41 includes a total of N integrators M₀, M₁, M₂, . . . , Mₙ₋₁, each provided for each power supply phase θ. In FIG. 6, four integrators M₀, M₁, M₂, and Mₙ₋₁ are specifically shown. The integrators are collectively denoted by M, and when distinguishing them, M₀, M₁, M₂, and Mₙ₋₁ are used. For example, consider a case where the control frequency Fct, which is the frequency of the control cycle, is 18 kHz, and the power supply frequency Fps of the three-phase AC power supply 1 is 60 Hz. The division number Ndv equals 18 k/60, which is 300. In other words, the angle of one cycle is divided into 300 angle ranges with respect to the power supply phase θ, and 300 integrators M₀ to Mₙ₋₁ are installed in the memory unit 41. The memory unit 41 stores the data integrated by each integrator M. Note that it may be considered that each integrator M in the memory unit 41 performs the integration when the input data Din is input and stores the integrated data. In this case, each integrator M in the memory unit 41 includes a memory to store the integrated data. Here, the output data Do output from the integrator M is data integrated and stored in the memory unit 41. Therefore, each integrator M corresponds to a power source phases θ of 1.2 degree (360 degrees/300), and each integrator M integrates the input data Din shifted by the phase deviation 40 being a deviation of 1.2 degree in the power source phase θ. The memory unit 41 further includes the selector 46a and the selector 46b.

Before inputting data into the memory unit 41 of the phase change feedback control unit 31, the proportional output unit 32 is placed to adjust the magnitude of the input data Din. The proportional output unit 32 is placed to prevent the compensation amount, that is, the output data Do, from becoming too large or too small. FIG. 6 shows an example where the proportional output unit 32 is placed before the memory unit 41, but the proportional output unit 32 can also be placed within the memory unit 41 or after the memory unit 41. In other words, the proportional output unit 32 only needs to be placed in the data path between the first terminal (data input terminal 49i) and the second terminal (data output terminal 49o).

The phase change feedback control unit 31 includes the proportional output unit 32 and the integrators M, and performs feedback control, and thus it can be said to be an improved version of a PI controller that performs the PI control. The input selection controller 43 accumulates the voltage deviation AV2 in any one of the integrators M₀ to Mₙ₋₁ corresponding to the power supply phase θ. The output selection controller 44 causes any one of the integrator M₀ to Mₙ₋₁ corresponding to the power supply phase θ that has been changed by the set phase a to output a compensation amount, that is, the output data Do. The input selection controller 43 outputs, to the selector 46a, a selection signal ssa for selecting an integrator M to which the input data Din is input. The selector 46a selects the integrator M to which the input data Din is input on the basis of the selection signal ssa. The output selection controller 44 outputs, to the selector 46b, a selection signal ssb for selecting an integrator M that outputs the output data Do. The selector 46b selects the integrator M that outputs the output data Do on the basis of the selection signal ssb. The set phase a needs to consider two types of delays: a delay caused by the controller 10 and a delay caused by the integration of the input data Din.

The delay caused by the controller 10 is a dead-time delay, which is due to a calculation time delay of the controller, such as a microcontroller. This typically corresponds to one control cycle (1/control frequency Fct).

An example of the delay caused by the integration of the input data Din will be described in relation to the reactor current. Let an inductance of the reactor be L, a reactor current of this reactor be iL, and a reactor voltage of this reactor be VL. The reactor current iL is expressed by Equation (8).

$${i}_{L} = \frac{1}{L} \int {V}_{L} dt \qquad ( 8 )$$

The reactor current iL is expressed by integration of the reactor voltage VL. Therefore, even when the reactor voltage VL is output, a certain period of time is required until the reactor voltage VL is reflected as a current value, and a delay corresponding to one control cycle needs to be taken into consideration. As described above, the two types of delays correspond to two control cycles. Therefore, the timing when the output data Do is output from the selector 46b, that is, the timing when the output selection controller 44 selects an integrator M, is set to be advanced by two control cycles compared to the timing when the input selection controller 43 selects an integrator M to which the input data Din is input. In other words, the integrator M corresponding to θ−2×Δθ, which is the phase advanced by 2× Δθ of the current power supply phase θ, outputs the integrated and stored data as the output data Do. Therefore, the set phase a is 2×Δθ. The set phase a has been described using the reactor current iL and the reactor voltage VL as an example, but since the delay caused by the integration is considered, the type of input data Din is not limited to the reactor voltage VL and may be the filter capacitor voltage Vin, voltage deviation ΔV2, etc. The set phase a may be set on the basis of the data obtained from an actual operation in response to the input data Din input into the phase change feedback control unit 31.

The phase change feedback control unit 31 shown in FIG. 5 inputs the voltage deviation ΔV2 output from the subtractor 21c as the input data Din and outputs the output data Do output from the integrator M of the memory unit 41 corresponding to the phase changed from the phase of the input data Din by the set phase a as the third command B3*. The second controller 10 generates the first command B1* as the first system command C1* by the first system control unit 35 and generates the third command B3* as the second system command C2* by the second system control unit 36 including the phase change feedback control unit 31. The subtractor 21d, which is the on-duty command generation unit 37, generates the on-duty command D* by subtracting the second system command C2* from the first system command C1*. The operation after the generation of the on-duty command D* is the same as that of the first controller 10. By using the phase change feedback control unit 31, the deviation becomes smaller each control cycle, and the filter capacitor voltage Vin can finally converge to the command value, that is, the filter capacitor voltage command Vin*.

Further, the first controller 10 may be modified to look like the third controller 10 shown in FIG. 7. The third controller 10 differs from the first controller 10 in that the phase change feedback control unit 31 is located in parallel with the damping feedback control unit 24. Even with the third controller 10, the deviation becomes smaller each control cycle, and the filter capacitor voltage Vin can finally converge to the command value, that is, the filter capacitor voltage command Vin*. The main components that differ from the first controllers 10 and the second controllers 10 will be described below.

The damping feedback control unit 24 and the phase change feedback control unit 31 are arranged in parallel so that the same input is input, and the second command B2* being the output of the damping feedback control unit 24, and the third command B3* being the output of the phase change feedback control unit 31 are input to a subtractor 21e. The second system control unit 36 in the third controller 10 has the subtractor 21c, the damping feedback control unit 24, the phase change feedback control unit 31, and the subtractor 21e. The voltage deviation ΔV2 generated by the subtractor 21c is input to the damping feedback control unit 24 and the phase change feedback control unit 31. The damping feedback control unit 24 outputs the second command B2* based on the voltage deviation ΔV2. The phase change feedback control unit 31 outputs the third command B3* being the output data Do, which is based on the voltage deviation ΔV2 being the input data Din. The subtracter 21e generates a deviation between the second command B2* and the third command B3* as the fourth command B4*. The fourth command B4* is the second system command C2* generated by the second system control unit 36.

The third controller 10 generates the first command B1* as the first system command C1* by the first system control unit 35, and generates the fourth command B4* as the second system command C2* by the second system control unit 36 including the damping feedback control unit 24 and the phase change feedback control unit 31. The subtractor 21d being the on-duty command generation unit 37 subtracts the second system command C2* from the first system command C1* to generate the on-duty command D*

Further, the first controller 10 may be modified to look like the fourth controller 10 shown in FIG. 8. The fourth controller 10 is different from the first controller 10 in that the first system control unit 35 does not include the current feedback control unit 23, the second system control unit 36 does not include the damping feedback control unit 24, and the on-duty command generation unit 37 includes the feedback control unit 33 and the phase change feedback control unit 31, the feedback control unit 33 having the functions of the current feedback control unit 23 and the damping feedback control unit 24, that is, the current feedback control function and the damping feedback control function. Differences from the first controller 10 and the second controller 10 will be mainly described. Note that the “feedback” of the feedback control unit in FIG. 8 is denoted as “FB”

The first system control unit 35 includes the subtractor 21a, the voltage feedback control unit 22, and the subtractor 21b, and generates the current deviation AI generated by the subtractor 21b as the first system command C1*. The second system control unit 36 includes the subtractor 21c and the proportional output unit 32 that multiplies the voltage deviation ΔV2 generated by the subtractor 21c by K, and generates a voltage deviation ΔV2a generated by the proportional output unit 32 as the second system command C2*. The on-duty command generation unit 37 includes the subtractor 21e, the feedback control unit 33, the phase change feedback control unit 31, and the subtractor 21d. The feedback control unit 33 and the phase change feedback control unit 31 are arranged in parallel so that the same input is input, and the fifth command B5* being the output of the feedback control unit 33, and the third command B3* being the output of the phase change feedback control unit 31 are input to the subtractor 21d. The subtractor 21e generates a composite deviation ΔQ, which is a deviation between the current deviation ΔI being the first system command C1* and the voltage deviation ΔV2a being the second system command C2*. The composite deviation ΔQ is input to the feedback control unit 33 and the phase change feedback control unit 31. The feedback control unit 33, which has the current feedback control function and the damping feedback control function, generates a fifth command B5* based on the composite deviation ΔQ. The phase change feedback control unit 31 generates the third command B3* being the output data Do based on the composite deviation ΔQ being the input data Din. The subtractor 21d generates the on-duty command D* as a deviation between the fifth command B5* and the third command B3*

The fourth controller 10 generates the current deviation AI as the first system command C1* by the first system control unit 35 and generates the voltage deviation ΔV2a as the second system command C2* by the second system control unit 36. The on-duty command generation unit 37 generates the on-duty command D* based on the composite deviation ΔQ, which is obtained by subtracting the second system command C2* from the first system command C1*.

In the fourth controller 10 shown in FIG. 8, an example is shown in which both the feedback control unit 33 and the phase change feedback control unit 31 are included. However, it is also possible to include only one of the feedback control unit 33 and the phase change feedback control unit 31. The proportional output unit 32 is configured to adjust a control amount for damping control only.

Furthermore, the first controller 10 may be modified to look like the fifth controller 10 shown in FIG. 9. The fifth controller 10 is an example where the filter focusing target 17 is a ripple component of the voltage in the filter 90, and the filter focusing target command 18 is a command for the ripple component of the voltage in the filter 90. Components that differ from those in the first controller 10 will be mainly described. The second system control unit 36, which generates the second system command C2*, includes the subtractor 21c and the damping feedback control unit 24. The subtractor 21c generates the ripple component deviation A Vrp as the deviation between the voltage ripple component ΔVin, which is the ripple component in the voltage of the filter 90 being the filter capacitor voltage Vin, and a command value of the voltage ripple component command ΔVin*, which is a target value of the voltage ripple component ΔVin. Specifically, the subtractor 21c generates the ripple component deviation ΔVrp by subtracting the voltage ripple component ΔVin from the voltage ripple component command ΔVin*.

Since the filter capacitor voltage Vin contains a DC component, the voltage ripple component ΔVin is extracted through the high-pass filter 27. The voltage ripple component ΔVin is input to the subtractor 21c. Since it is desirable that the filter capacitor voltage Vin does not oscillate, the command value of the voltage ripple component ΔVin, that is, the command value of the voltage ripple component command ΔVin* should be set to zero.

The damping feedback control unit 24 outputs the second command B2* as the second system command C2* based on the ripple component deviation ΔVrp. The fifth controller 10 generates the first command B1* as the first system command C1* by the first system control unit 35, and generates the second command B2* as the second system command C2* by the second system control unit 36. The subtractor 21d being the on-duty command generation unit 37 subtracts the second system command C2* from the first system command C1* to generate the on-duty command D*. The operation after the generation of the on-duty command D* is the same as that of the first controller 10.

An example of the controller 10 in which the filter focusing target 17 is the voltage ripple component ΔVin in the filter capacitor voltage Vin of the filter 90, and the filter focusing target command 18 is the voltage ripple component command ΔVin*, which is the command for the ripple component of the filter capacitor voltage Vin of the filter 90, has been described in the fifth controller 10 shown in FIG. 5. However, the filter focusing target 17 and the filter focusing target command 18 in the second controller 10 shown in FIG. 5, the third controller 10 shown in FIG. 7, and the fourth controller 10 shown in FIG. 8 may also be the voltage ripple component ΔVin and the voltage ripple component command ΔVin*. In this case as well, the ripple component deviation ΔVrp becomes smaller each control cycle, and the voltage ripple component ΔVin of the filter capacitor voltage Vin can ultimately converge to the command value, that is, the voltage ripple component command A Vin*.

Next, operation waveforms of the power conversion device 50 of Embodiment 1 will be described in comparison with the comparative example. FIG. 10 shows an operation waveform of the power conversion device in the comparative example, and FIG. 11 and FIG. 12 show operation waveforms of the power conversion device 50 of Embodiment 1. Note that the operation waveform of the power conversion device 50 of Embodiment 1 is denoted as the operation waveform of Example 1 as appropriate. The diagrams of the operation waveforms shown in FIG. 11 and FIG. 12 are those of the power conversion device 50 including the first controller 10. The power conversion device of the comparative example differs from the power conversion device 50 of Embodiment 1 in that it does not include the second system control unit 36.

First, the operation waveform of the comparative example shown in FIG. 10 will be described. FIG. 10 shows a current characteristic 82 of the power supply current Ips. The power supply current Ips is the current of one phase of the three-phase AC. In FIG. 10, the horizontal axis represents time [s], and the vertical axis represents power supply current Ips [A]. Note that the horizontal and vertical axes in FIG. 11 and FIG. 12 are the same as the horizontal and vertical axes in FIG. 10. The current characteristic 82 of the power supply current Ips in the comparative example shows that the power supply current Ips fluctuates greatly, and the current in a manner resembling “rabbit ears” flows as the power supply current Ips. Since the power conversion device of the comparative example does not include the second system control unit 36 that has the damping feedback control unit 24 for the ripple reduction, the current characteristic 82 of the power supply current Ips in the comparative example shows large ripple in the power supply current, and only with the normal current feedback control unit 23, the distortion of the current waveform remains significantly.

Next, the operation waveforms of Example 1 will be described. FIG. 11 shows a current characteristic 81a of the power supply current Ips, and FIG. 12 shows a current characteristic 81b of the power supply current Ips. The operation waveform of Example 1 shown in FIG. 11 has less waveform distortion compared to the comparative example. Therefore, it can be confirmed that the control performance of the second system control unit 36 that includes the damping feedback control unit 24 for the ripple reduction is effective.

The operation waveform of Example 1 shown in FIG. 12 is the waveform obtained when the characteristic of the filter 90 is optimized. The operation waveform in FIG. 12 is for the case where the filter 90 includes the filter reactor 8 and the filter capacitor 9. The resonant frequency Fre depending on the filter capacitor 9 and the filter reactor 8 in the filter 90 is set to be 18 times or more the frequency of the three-phase AC (power supply frequency Fps) and equal to or lower than half of the frequency of the carrier wave 26 (carrier frequency Fca). The resonant frequency Fre [Hz] in the filter 90 of Example 1 can be expressed by Equation (9).

$$Fre = 1 / ( 2 π \times √ ( Lf \times Cf ) ) \qquad ( 9 )$$

Here, Lf is the filter inductance of the filter reactor 8, and Cf is the filter capacitance of the filter capacitor 9.

The current characteristic 81b of the power supply current Ips in FIG. 12 have less waveform distortion compared to the current characteristic 81a of the power supply current Ips in FIG. 11 and the current can be considered as a rectangular wave current.

A method of setting the parameters of the filter 90, that is, the filter inductance Lf and the filter capacitance Cf, will be described. First, in consideration of the removal of the carrier ripple current, the filter 90 including the filter reactor 8 and the filter capacitor 9 is operated as a low pass filter to remove the carrier ripple current generated in the step-down converter 91a. The resonant frequency Fre of the filter 90 should be set to be lower than the carrier frequency Fca so that attenuation is effective in the band of the carrier frequency Fca. For example, when the resonant frequency Fre is set to be equal to or lower than half the carrier frequency Fca, the current passing through the filter 90 in the band of the carrier frequency Fca can be attenuated. Therefore, in order to remove the carrier ripple current, the upper limit of the resonant frequency Fre of the filter 90 should be half of the carrier frequency Fca.

Next, a method of reducing the distortion of the power supply current Ips will be considered. When the AC power is converted into the DC power by using the rectifier circuit 2, if the resonant frequency Fre of the filter 90 is low, a spike-shaped current including harmonics such as “rabbit ears” is generated in the power supply current Ips. If the filter inductance Lf of the filter reactor 8 is increased as a countermeasure against this, the power supply current Ips is rounded to have a rectangular waveform. However, when the power supply current Ips is made to have a rectangular waveform by taking measures only with the filter inductance Lf, the filter inductance Lf becomes too large, and thus the size of the filter 90 increases and the cost of the filter 90 also increases. Therefore, as another method of reducing the distortion of the power supply current Ips, there is a method of increasing the resonant frequency Fre of the filter 90. The resonant frequency Fre is preferably higher than the power supply frequency Fps, but if the resonant frequency Fre is approximately 18 times or more the power supply frequency Fps, the power supply current Ips can be regarded as a rectangular wave current. When the resonant frequency Fre are 18 times or more the power supply frequency Fps, unlike the current characteristic 82 of the power supply current Ips in the comparative example, a plurality of current rises can be eliminated even if there is some fluctuation during one cycle of the power supply current Ips of each phase. Therefore, in order to reduce the distortion of the power supply current Ips and to make the power supply current Ips a rectangular wave current, the lower limit of the resonant frequency Fre of the filter 90 should be 18 times the power supply frequency Fps. If the filter capacitance Cf of the filter capacitor 9 is too large, the power supply current Ips does not become a rectangular wave current. Therefore, a film capacitor having a small filter capacitance Cf and a large current rating should be used as the filter capacitor 9.

The resonant frequency Fre of the filter 90 should satisfy both of a condition that is equal to or lower than half the carrier frequency Fca and a condition that is equal to or higher than 18 times the power supply frequency Fps. For example, the parameters of the filter 90 in the power conversion device 50 according to Embodiment 1, that is, the filter inductance Lf and the filter capacitance Cf are Lf=200 μH and Cf=10 μF. The resonant frequency Fre can be calculated from Equation (9). In this case, the resonant frequency Fre is about 3600 Hz, which is about one fourth of the carrier frequency Fca and 60 times the power supply frequency Fps.

Although the output of the rectifier circuit 2 includes a ripple containing components of a multiple of 6 (6 times, 12 times, 18 times, or the like) of the power supply frequency Fps, the resonant frequency Fre of the filter 90 is preferably high in order to improve the characteristics of the rectifier circuit 2. When the resonant frequency Fre of the filter 90 is increased from six times the power supply frequency Fps to three times further thereof, that is, to 18 times the power supply frequency Fps, the output of the rectifier circuit 2 can obtain a favorable characteristic.

The power conversion device 50 of Embodiment 1 can prevent the breakage of the peripheral devices by reducing the outflow of the carrier ripple current. Further, by reducing the distortion of the power supply current Ips, component losses can be reduced, and a component with a small current rating can be applied. In addition, the power conversion device 50 of Embodiment 1 can reduce the current distortion, so that the inductance of the control reactor 5 can be reduced.

Note that functions of the subtractors 21a to 21e, the voltage feedback control unit 22, the current feedback control unit 23, the damping feedback control unit 24, the phase change feedback control unit 31, the feedback control unit 33, the phase voltage calculation unit 15, the filter voltage command generation unit 16, and the carrier comparison unit 25, which are functional blocks of the controller 10, may be implemented by a processor 98 and a memory 99 shown in FIG. 24. FIG. 24 is a diagram showing an example of a hardware configuration for implementing the functions of the controller by digital computation. In this case, the subtractors 21a to 21e, the voltage feedback control unit 22, the current feedback control unit 23, the damping feedback control unit 24, the phase change feedback control unit 31, the feedback control unit 33, the phase voltage calculation unit 15, the filter voltage command generation unit 16, and the carrier comparison unit 25 are implemented by the processor 98 executing a program stored in the memory 99. In addition, a plurality of the processors 98 and a plurality of the memories 99 may execute each function in cooperation with each other.

Note that the switching element 3 may be a silicon semiconductor element formed using silicon or a wide bandgap semiconductor element formed using a wide bandgap semiconductor material having a bandgap larger than that of silicon. Examples of the wide bandgap semiconductor material include silicon carbide (SiC), gallium nitride material such as gallium nitride (GaN), and diamond. As a semiconductor material for the diode 4, silicon or a wide bandgap semiconductor material can be used as in the case of the switching element 3. When the switching element 3 and the diode 4 are semiconductor elements formed of a wide bandgap semiconductor material, that is, wide bandgap semiconductor elements, the switching speed and the operation speed are higher and the loss such as the switching loss is smaller than those of silicon semiconductor elements. Further, the wide bandgap semiconductor elements have higher voltage resistance and higher heat resistance than the silicon semiconductor elements. Therefore, when the switching element 3 and the diode 4 are the wide bandgap semiconductor elements, a heat sink or the like that is a cooler for the switching element 3 and the diode 4 can be downsized, or the heat sink or the like may be unnecessary.

As described above, the power conversion device 50 of Embodiment 1 includes the rectifier circuit 2 that converts the input voltages (interphase voltage Vac) of the three-phase AC input from the AC input terminals 55r, 55s, and 55t into the DC voltage, the converter 91 that outputs the output voltage Vo set to the set voltage value from the DC voltage output from the rectifier circuit 2, the smoothing capacitor 6 connected between the positive-side converter output terminal (DC output terminal 64p) and the negative-side converter output terminal (DC output terminal 64n) of the converter 91 from which the output voltage Vo is output, the filter 90 disposed between the AC input terminals 55r, 55s, and 55t and the converter 91 and including the filter capacitor 9, and the controller 10 that controls the converter 91. The converter 91 includes the switching element 3 that is controlled with PWM by the control signal sig1 generated on the basis of the carrier wave 26 and the on-duty command D*. The controller 10 designates the voltage of the filter 90 (filter capacitor voltage Vin) or the ripple component of the voltage of the filter 90 (voltage ripple component ΔVin) as the filter focusing target 17. It generates the on-duty command D* for reducing the difference between the detection value of the filter focusing target 17 and the target value of the filter focusing target (filter focusing target command 18). In the power conversion device 50 of Embodiment 1, with this configuration, since the filter 90 including the filter capacitor 9 is disposed between the AC input terminals 55r, 55s, and 55t, and the converter 91, and the controller 10 generates the on-duty command D* for reducing the difference between the detection value and the target value (filter focusing target command 18) in the filter focusing target 17, which is the voltage of the filter 90 (filter capacitor voltage Vin) or the ripple component (voltage ripple component ΔVin) in the voltage of the filter 90, it is possible to reduce the carrier ripple current and to reduce the outflow of the carrier ripple current to the power supply.

### Embodiment 2

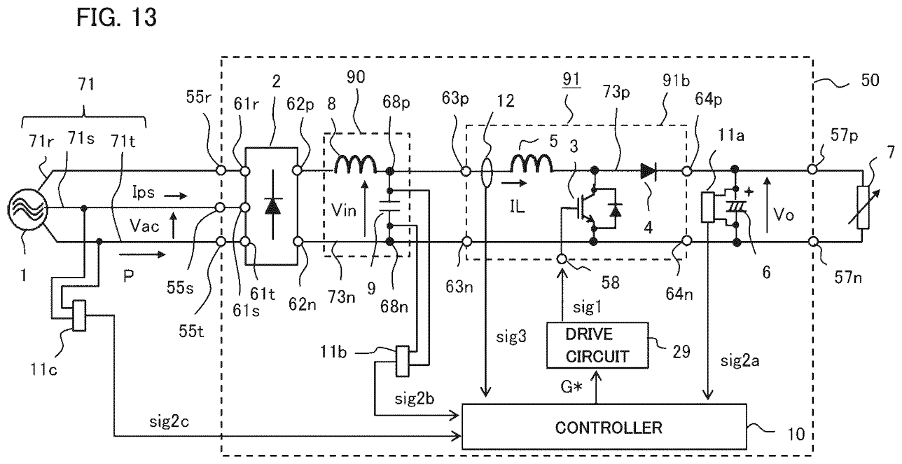

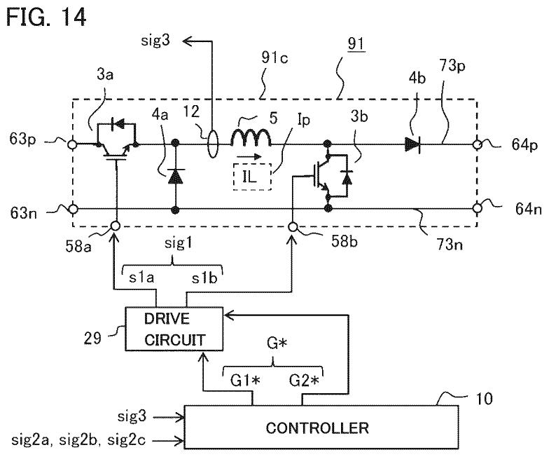

FIG. 13 is a diagram showing a configuration of a power conversion device according to Embodiment 2, and FIG. 14 is a diagram showing a configuration of another example of the converter of FIG. 13. The power conversion device 50 of Embodiment 2 is different from the power conversion device 50 of Embodiment 1 in that the converter 91 is a step-up converter 91b or a step-up/step-down converter 91c. The differences from the power conversion device 50 of Embodiment 1 will be mainly described.

FIG. 13 shows an example in which the converter 91 is the step-up converter 91b. FIG. 14 shows an example in which the converter 91 is a step-up/step-down converter 91c. In the step-up converter 91b, which is an example of the converter 91, one end of the control reactor 5 is connected to the positive DC input terminal 63p, and the other end of the control reactor 5 is connected to the collector of the switching element 3 and the anode of the diode 4. The cathode of the diode 4 is connected to the positive-side DC output terminal 64p. The control reactor 5 and the diode 4 are inserted in the positive-side line 73p. The emitter of the switching element 3 is connected to the negative-side line 73n, and is connected to the DC input terminal 63n and the DC output terminals 64n by the negative-side line 73n. The gate of the switching element 3 is connected to the control terminal 58. The control terminal 58 receive the control signal sig1 whose voltage value is changed by the drive circuit 29 on the basis of the gate signal command G* output from the controller 10. The control signal sig1 is a signal for controlling the ON state and the OFF state of the switching element 3 by, for example, PWM control. The current sensor 12 for detecting the control reactor current IL being the current of the control reactor 5 is disposed between the DC input terminal 63p and one end of the control reactor 5.

The filter 90 serves to reduce a carrier ripple current generated in the converter 91 such as the step-up converter 91b and to reduce the outflow of the carrier ripple current to the power supply. Further, the role of the filter 90 can also be described as follows. The filter 90 serves to reduce distortion of the power supply current Ips due to the carrier ripple current generated in the converter 91 such as the step-up converter 91b, and to reduce the current distortion of the power supply current Ips in a shape resembling “rabbit ears”, that is, a spike shape. In Embodiment 2, an example in which the filter 90 includes the filter reactor 8 will be described, however, the filter 90 may not include the filter reactor 8.

The first to fifth controller 10 in Embodiment 1 can be applied to the controller 10 in Embodiment 2. Since the same control configuration as that of Embodiment 1 can be used, a detailed description thereof will be omitted. However, the smoothing capacitor voltage command Vdc* being the voltage command for controlling the output voltage Vo, which is the voltage of the smoothing capacitor 6, is determined to be an arbitrary value. Since the converter 91 is the step-up converter 91b, the smoothing capacitor voltage command Vdc* should be set to be larger than the voltage of the filter capacitor 9 input to the step-up converter 91b.

The input side of the step-up converter 91b is the control reactor 5, and a waveform such as a triangular wave is input to the step-up converter 91b, and therefore, the generated carrier ripple current is smaller than that of the step-down converter 91a. However, the filter 90 and the method of selecting the parameters of the filter 90 described in Embodiment 1 are effective in reducing the carrier ripple current and the outflow of the carrier ripple current to the power supply.

Note that, although FIG. 13 shows an example in which the step-up converter 91b has a two-level configuration, it is needless to say that the number of switching elements 3 can be increased to have a three-level configuration, etc. in which a plurality of the switching elements 3 are connected in series. Similarly, the step-down converter 91a described in Embodiment 1 may be set to be the three-level. The converter 91 may be the step-up/step-down converter 91c having both the function of the step-up converter 91b and the function of the step-down converter 91a.

The step-up/step-down converter 91c shown in FIG. 14 includes two switching elements 3a and 3b, the control reactor 5, and two diodes 4a and 4b. The configuration including the switching element 3a, the diode 4a, and the control reactor 5 is the same as that of the step-down converter 91a described in Embodiment 1. The configuration including the control reactor 5, the switching element 3b, and the diode 4b is the same as that of the step-up converter 91b shown in FIG. 13. In the step-up/step-down converter 91c, the collector of the switching element 3a is connected to the DC input terminal 63p, and the emitter of the switching element 3a is connected to the cathode of the diode 4a and one end of the control reactor 5. The other end of the control reactor 5 is connected to the collector of the switching element 3b and the anode of the diode 4b. The cathode of the diode 4b is connected to the DC output terminal 64p. The anode of the diode 4a and the emitter of the switching element 3b are connected to the negative-side line 73n, and are connected to the DC input terminal 63n and the DC output terminal 64n by the negative-side line 73n. The switching element 3a, the control reactor 5, and the diode 4b are inserted into the positive-side line 73p. The gate of the switching element 3a is connected to a control terminal 58a, and the gate of the switching element 3b is connected to a control terminal 58b.

The control terminals 58a and 58b receive a control signal sig1 whose voltage value is changed by the drive circuit 29 on the basis of the gate signal command G* output from the controller 10. To be more specific, the control signal s1a whose voltage value is changed by the drive circuit 29 on the basis of the gate signal command G1* output from the controller 10 is input to the control terminal 58a. The control signal s1b whose voltage value is changed by the drive circuit 29 on the basis of the gate signal command G2* output from the controller 10 is input to the control terminal 58b. The reference signs for the control signals input to the control terminals 58a and 58b are collectively denoted by sig1, and the reference signs s1a and s1b are used for distinction. The reference signs for the gate signal commands output from the controller 10 are collectively denoted by G*, and are distinguished by G1* and G2*. The current sensor 12 for detecting the control reactor current IL being the current of the control reactor 5 is disposed between the emitter of the switching element 3a and one end of the control reactor 5. The control reactor current IL detected by the current sensor 12 is also the current flowing through the positive-side line 73p, and thus is also the positive-side line current Ip, as with the control reactor current IL shown in FIG. 1 and FIG. 13. The control signal sig1 is a signal for controlling the ON state and the OFF state for the switching elements 3a and 3b by, for example, PWM control. When the step-up/step-down converter 91c is caused to function as a step-down converter, the switching element 3b is turned in the OFF state, and the switching element 3a is controlled to be in the ON state and the OFF state. When the step-up/step-down converter 91c is caused to function as a step-up converter, the switching element 3a is turned in the ON state, and the switching element 3b is controlled to be in the ON state and the OFF state. Note that, although FIG. 14 shows an example in which the step-up/step-down converter 91c has the two-level configuration, it is needless to say that the number of switching elements 3 can be increased to have a three-level configuration, etc. in which a plurality of the switching elements 3 are connected in series.

The power conversion device 50 of Embodiment 2 can prevent the breakage of the peripheral devices by reducing the outflow of the carrier ripple current, as in the power conversion device 50 of Embodiment 1. Further, by reducing the distortion of the power supply current Ips, component losses can be reduced, and a component with a small current rating can be applied. In addition, the power conversion device 50 of Embodiment 2 can reduce the current distortion, so that the inductance of the control reactor 5 can be reduced. In the power conversion device 50 of Embodiment 2 as in the power conversion device 50 of Embodiment 1, since the filter 90 including the filter capacitor 9 is disposed between the AC input terminals 55r, 55s, and 55t, and the converter 91, and the controller 10 generates the on-duty command D* that reduces the difference between the detection value and the target value (filter focusing target command 18) in the filter focusing target 17, which is the voltage of the filter 90 (filter capacitor voltage Vin) or the ripple component (voltage ripple component ΔVin) in the voltage of the filter 90, it is possible to reduce the carrier ripple current and to reduce the outflow of the carrier ripple current to the power supply.

### Embodiment 3

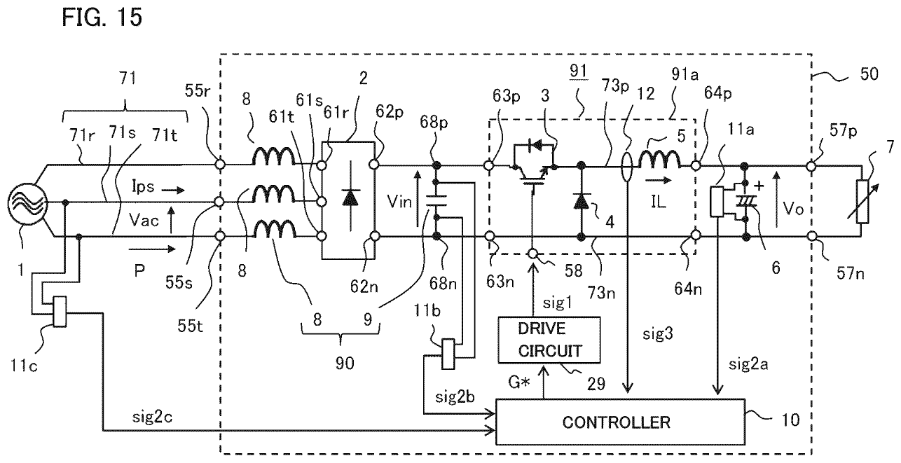

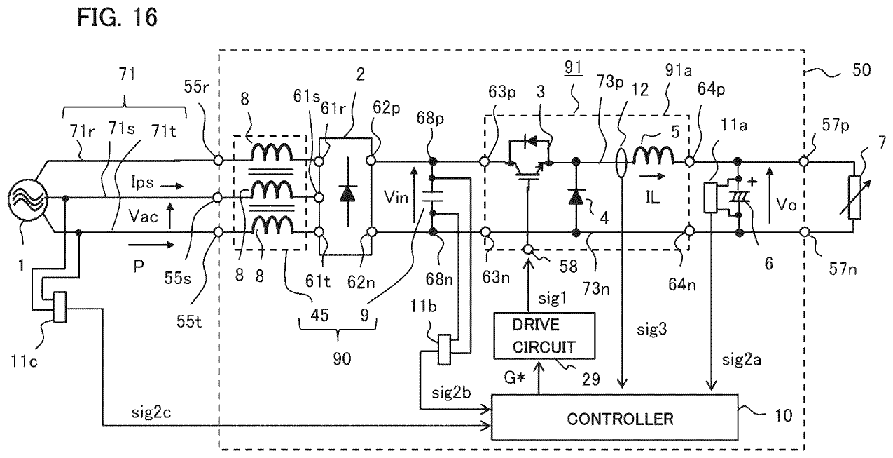

FIG. 15 is a diagram showing a configuration of a first power conversion device according to Embodiment 3, and FIG. 16 is a diagram showing a configuration of a second power conversion device according to Embodiment 3. In Embodiment 1 and Embodiment 2, the examples are shown in which the filter reactor 8 of the filter 90 is disposed between the rectifier circuit 2 connected to the AC input terminals 55r, 55s, and 55t, and the converter 91. However, the filter reactor 8 may be disposed between the AC input terminals 55r, 55s, and 55t, and the rectifier circuit 2. The power conversion device 50 of Embodiment 3 is different from the power conversion devices 50 of Embodiment 1 and Embodiment 2 in that the filter reactor 8 is disposed between the AC input terminals 55r, 55s, and 55t, and the rectifier circuit 2. The following description will focus on differences from the power conversion devices 50 of Embodiment 1 and Embodiment 2.

In a first power conversion device 50 of Embodiment 3 shown in FIG. 15, a first filter reactor 8 is connected between the AC input terminal 55r and the AC input terminal 61r being a rectifier circuit input terminal of the rectifier circuit 2. Similarly, a second filter reactor 8 is connected between the AC input terminal 55s and the AC input terminal 61s being a rectifier circuit input terminal of the rectifier circuit 2, and a third filter reactor 8 is connected between the AC input terminal 55t and the AC input terminal 61t being a rectifier circuit input terminal of the rectifier circuit 2. The filter 90 of Embodiment 3 includes three filter reactors 8 and the filter capacitor 9, with the rectifier circuit 2 interposed between the reactors and the filter capacitor. The three filter reactors 8 shown in FIG. 15 are on the AC side (alternating current side), and therefore can be referred to as AC reactors.

Although a total of three filter reactors 8 are required on the AC side because three-phase AC is input, the LC filter 90 can be effectively operated even in such a configuration. Note that the value of the filter inductance Lf of the filter reactor 8 is doubled because the current passes through the filter reactor 8 twice in the forward and backward directions.

Further, a second power conversion device 50 of Embodiment 3 may have a configuration as shown in FIG. 16. The reactor of a common mode choke coil 45 to be installed for noise removal can be used as the filter reactor 8. In the second power conversion device 50 of Embodiment 3, the filter reactors 8 are connected between the AC input terminals 55r, 55s, and 55t, and the AC input terminals 61r, 61s, and 61t being the rectifier circuit input terminals of the rectifier circuit 2, and the three filter reactors 8 corresponding to the respective phases of the three-phase AC constitute the common mode choke coil 45. The common mode choke coil 45 is normally effective for the common mode, but can be used for the normal mode because it has a slight inductance.

The power conversion device 50 of Embodiment 3 can prevent the breakage of the peripheral devices by reducing the outflow of the carrier ripple current, similarly to the power conversion devices 50 of Embodiment 1 and Embodiment 2. Furthermore, by reducing the distortion of the power supply current Ips, component losses can be reduced, and a component with a small current rating can be applied. In addition, the power conversion device 50 of Embodiment 3 can reduce the current distortion, so that the inductance of the control reactor 5 can be reduced. In the power conversion device 50 of Embodiment 3, the filter 90 including the three filter reactors 8 and the filter capacitor 9 is disposed between the AC input terminals 55r, 55s, and 55t, and the converter 91, and more specifically, the three filter reactors 8 are disposed closer to the AC input terminals 55r, 55s, and 55t than the filter capacitor 9, with the rectifier circuit 2 interposed between the filter reactors and filter capacitor, and the controller 10 generates the on-duty command D* that reduces the difference between the detection value and the target value (filter focusing target command 18) in the filter focusing target 17, which is the voltage of the filter 90 (filter capacitor voltage Vin) or the ripple component (voltage ripple component ΔVin) in the voltage of the filter 90. Therefore, it is possible to reduce the carrier ripple current and to reduce the outflow of the carrier ripple current to the power supply.

### Embodiment 4

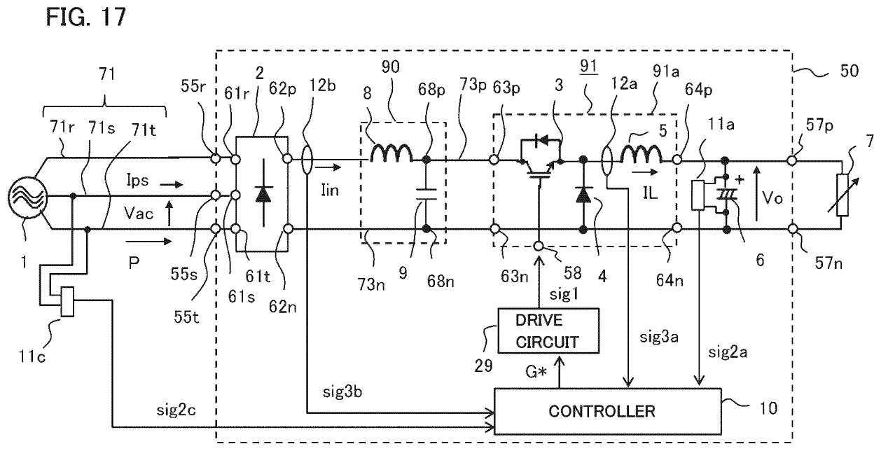

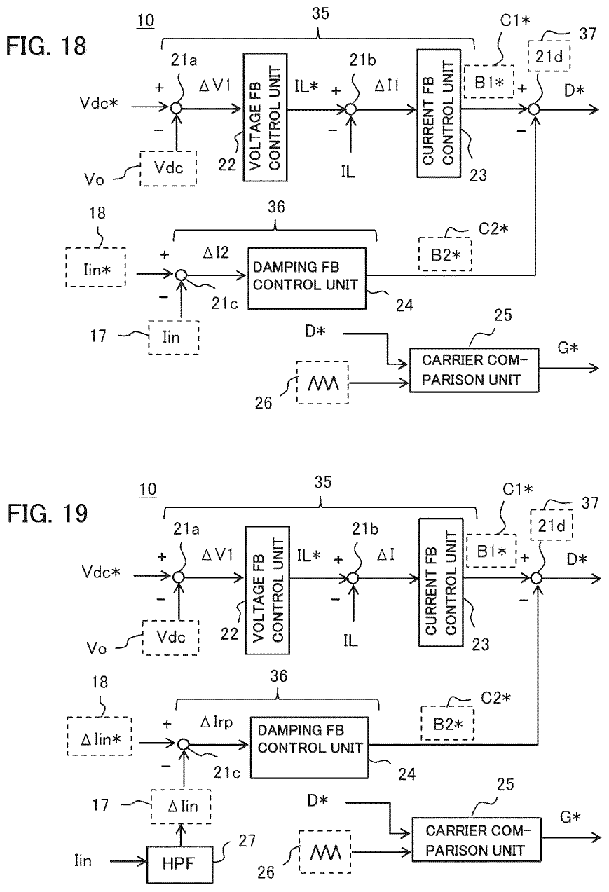

FIG. 17 is a diagram showing a configuration of a power conversion device according to Embodiment 4. FIG. 18 is a diagram showing a configuration of a first controller according to Embodiment 4, and FIG. 19 is a diagram showing a configuration of a second controller according to Embodiment 4. In the power conversion device 50 of Embodiment 1 to Embodiment 3, an example of using the filter capacitor voltage Vin as the filter focusing target 17 is shown, but a rectifier circuit current Iin, which is output from the rectifier circuit 2 and input to the filter 90, may also be used as the filter focusing target 17. The power conversion device 50 of Embodiment 4 differs from the power conversion device 50 of Embodiment 1 to Embodiment 3 in that it uses the rectifier circuit current Iin as the filter focusing target 17. The differences from the power conversion device 50 of Embodiment 1 to Embodiment 3 will be mainly described.

The power conversion device 50 of Embodiment 4 shown in FIG. 17 does not include a voltage sensor 11b for detecting the filter capacitor voltage Vin but includes a current sensor 12b for detecting the rectifier circuit current Iin flowing into the filter 90. The power conversion device 50 of Embodiment 4 is an example in which two current sensors 12a and 12b are included. The current sensor 12a for detecting the control reactor current IL of the control reactor 5 is the same as the current sensor 12 in the power conversion device 50 of Embodiment 1, which detects the control reactor current IL of the control reactor 5. The rectifier circuit current Iin is the current output by the rectifier circuit 2 and is the current right after the rectifier circuit 2.

FIG. 18 shows the first controller 10 with the rectifier circuit current Iin as the filter focusing target 17, and FIG. 19 shows the second controller 10 with a current ripple component ΔIin of the rectifier circuit current Iin as the filter focusing target 17. First, the first controller 10 of Embodiment 4 will be described. The first controller 10 of Embodiment 4 shown in FIG. 18 differs from the first controller 10 of Embodiment 1 shown in FIG. 5 in that the rectifier circuit current Iin is input as the filter focusing target 17 to the subtractor 21c of the second system control unit 36 that generates the second system command C2*, and a current command Iin* of the rectifier circuit current Iin is input as the filter focusing target command 18. Other configurations are the same as the first controller 10 of Embodiment 1 shown in FIG. 5. Note that in FIG. 18, the phase voltage calculation unit 15 and the filter voltage command generation unit 16 described in FIG. 2 are omitted.

The differences from the first controller 10 of Embodiment 1 shown in FIG. 5 will be mainly described. The subtractor 21c generates a current deviation ΔI2 as the deviation between the rectifier circuit current Iin being the current of the filter 90 and a command value of the current command Iin* being the target value of the rectifier circuit current Iin. Specifically, the subtractor 21c generates the current deviation ΔI2 by subtracting the rectifier circuit current Iin from the current command Iin*. The reference sign of the current deviation generated by the subtractor 21b in the first system control unit 35 that generates the first system command C1* is denoted as ΔI1 to distinguish it from the current deviation ΔI2.

The damping feedback control unit 24 outputs the second command B2* as the second system command C2* based on the current deviation ΔI2. The first controller 10 generates the first command B1* as the first system command C1* by the first system control unit 35 and generates the second command B2* as the second system command C2* by the second system control unit 36. The subtractor 21d being the on-duty command generation unit 37 generates the on-duty command D* by subtracting the second system command C2* from the first system command C1*. The operation after the generation of the on-duty command D* is the same as that of the first controller 10.

Next, the second controller 10 of Embodiment 4 will be described. The second controller 10 of Embodiment 4 shown in FIG. 19 differs from the fifth controller 10 of Embodiment 1 shown in FIG. 9 in that the current ripple component ΔIin of the rectifier circuit current Iin is input as the filter focusing target 17 to the subtractor 21c in the second system control unit 36 that generates the second system command C2*, a current ripple component command ΔIin* being a command of the current ripple component ΔIin is input as the filter focusing target command 18, and a ripple component deviation ΔIrp is output from the subtractor 21c. Other configurations are the same as the fifth controller 10 of Embodiment 1 shown in FIG. 9.

The differences from the fifth controller 10 of Embodiment 1 will be described. The subtractor 21c generates, as the ripple component deviation ΔIrp, the deviation between the current ripple component ΔIin, which is the ripple component in the current of the filter 90, that is, the rectifier circuit current Iin, and a command value of the current ripple component command ΔIin*, which is the target value of the current ripple component ΔIin. Specifically, the subtractor 21c generates the ripple component deviation ΔIrp by subtracting the current ripple component ΔIin from the current ripple component command ΔIin*. Since the rectifier circuit current Iin contains a DC component, the current ripple component ΔIin is extracted through the high-pass filter 27. The current ripple component ΔIin is input to the subtractor 21c. Since it is desirable that the rectifier circuit current Iin does not oscillate, the command value of the current ripple component ΔIin, that is, the command value of the current ripple component command ΔIin*, should be set to zero.

The damping feedback control unit 24 outputs the second command B2* as the second system command C2* based on the ripple component deviation ΔIrp. The second controller 10 generates the first command B1* as the first system command C1* by the first system control unit 35, and generates the second command B2* as the second system command C2* by the second system control unit 36. The subtractor 21d being the on-duty command generation unit 37 generates the on-duty command D* by subtracting the second system command C2* from the first system command C1*. The operation after the generation of the on-duty command D* is the same as that of the fifth controller 10 of Embodiment 1 shown in FIG. 9.

The controller 10 of Embodiment 4 in which the rectifier circuit current Iin is input as the filter focusing target 17 to the subtractor 21c in the second system control unit 36 that generates the second system command C2*, and the current command Iin* of the rectifier circuit current Iin is input as the filter focusing target command 18 can be applied not only to the first controller 10 shown in FIG. 8 but also to the controllers 10 of Embodiment 1 shown in FIG. 5, FIG. 7, and FIG. 8. In the controllers 10 shown in FIG. 5, FIG. 7, and FIG. 8 of Embodiment 1, the rectifier circuit current Iin should be input as the filter focusing target 17 to the subtractor 21c in the second system control unit 36 that generates the second system command C2*, and the current command Iin* of the rectifier circuit current Iin should be input as the filter focusing target command 18.

The controller 10 of Embodiment 4 in which the current ripple component ΔIin of the rectifier circuit current Iin is input as the filter focusing target 17 to the subtractor 21c in the second system control unit 36 that generates the second system command C2*, and the current ripple component command ΔIin* being the command of the current ripple component ΔIin is input as the filter focusing target command 18 can be applied not only to the first controller 10 shown in FIG. 8 but also to the controllers 10 of Embodiment 1 shown in FIG. 5, FIG. 7, and FIG. 8. In the controllers 10 shown in FIG. 5, FIG. 7, and FIG. 8 of Embodiment 1, the current ripple component ΔIin of the rectifier circuit current Iin should be input as the filter focusing target 17 to the subtractor 21c in the second system control unit 36 that generates the second system command C2*, and the current ripple component command ΔIin* being the command of the current ripple component ΔIin should be input as the filter focusing target command 18. Note that the output of the subtractor 21c will be the ripple component deviation ΔIrp.

The power conversion device 50 of Embodiment 4 can prevent the breakage of the peripheral devices by reducing the outflow of the carrier ripple current, similarly to the power conversion devices 50 of Embodiment 1 and Embodiment 2. Further, by reducing the distortion of the power supply current Ips, component losses can be reduced, and a component with a small current rating can be applied. In addition, the power conversion device 50 of Embodiment 4 can reduce the current distortion, so that the inductance of the control reactor 5 can be reduced.

As described above, the power conversion device 50 of Embodiment 4 includes the rectifier circuit 2 that converts the input voltages (interphase voltage Vac) of the three-phase AC input from the AC input terminals 55r, 55s, and 55t into the DC voltage, the converter 91 that outputs the output voltage Vo set to the set voltage value from the DC voltage output from the rectifier circuit 2, the smoothing capacitor 6 connected between the positive-side converter output terminal (DC output terminal 64p) and the negative-side converter output terminal (DC output terminal 64n) of the converter 91 from which the output voltage Vo is output, the filter 90 disposed between the AC input terminals 55r, 55s, and 55t, and the converter 91a and including the filter capacitor 9, and the controller 10 that controls the converter 91. The converter 91 includes the switching element 3 that is controlled with PWM by the control signal sig1 generated on the basis of the carrier wave 26 and the on-duty command D*. The controller 10 designates the current of the filter 90 (rectifier circuit current Iin) or the ripple component of the current of the filter 90 (current ripple component ΔIin) as the filter focusing target 17. It generates the on-duty command D* that reduces the difference between the detection value of the filter focusing target 17 and the target value of the filter focusing target (filter focusing target command 18). In the power conversion device 50 of Embodiment 4, with this configuration, since the filter 90 including the filter capacitor 9 is disposed between the AC input terminals 55r, 55s, and 55t, and the converter 91, and the controller 10 generates the on-duty command D* that reduces the difference between the detection value and the target value (filter focusing target command 18) in the filter focusing target 17, which is the current of the filter 90 (rectifier circuit current Iin) or the ripple component (current ripple component ΔIin) in the current of the filter 90, it is possible to reduce the carrier ripple current and to reduce the outflow of the carrier ripple current to the power supply.

### Embodiment 5

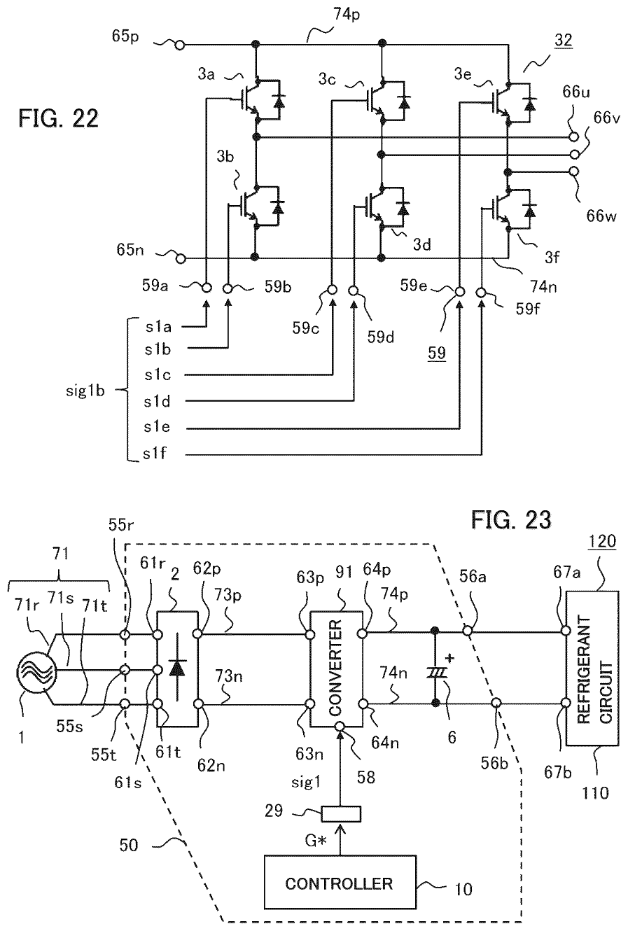

FIG. 20 is a diagram showing a configuration of a first refrigeration cycle apparatus according to Embodiment 5. FIG. 21 is a diagram showing a configuration of a refrigerant circuit of FIG. 20, and FIG. 22 is a diagram showing a configuration of an inverter of FIG. 20. FIG. 23 is a diagram showing a configuration of a second refrigeration cycle apparatus according to Embodiment 5. In Embodiment 5, a refrigeration cycle apparatus 120 in which the power conversion device 50 including the converter 91, the filter 90, and the controller 10 according to Embodiment 1 to Embodiment 4 is mounted will be described.

The refrigeration cycle apparatus 120 includes a refrigerant circuit 110 that constitutes a refrigeration cycle in which a refrigerant circulates while changing in repeated processes of “compression”, “condensation”, “expansion”, and “evaporation”. Examples of the refrigeration cycle apparatus 120 include an air conditioner and a refrigeration device. In the following description, an air conditioner as the refrigeration cycle apparatus 120 will be described as an example.

A first power conversion device 50 of Embodiment 5 shown in FIG. 20 is a power conversion device in which an inverter 92 is added to the power conversion device 50 of Embodiment 1 to Embodiment 4. A second power conversion device 50 of Embodiment 5 shown in FIG. 23 is the power conversion device 50 of Embodiment 1 to Embodiment 4. In the first power conversion device 50 of Embodiment 5 shown in FIG. 20, the DC output terminal 64p of the converter 91 and a DC input terminal 65p of the inverter 92 are connected by a positive-side power line 74p, and the DC output terminal 64n of the converter 91 and a DC input terminal 65n of the inverter 92 are connected by a negative-side power line 74n. In FIG. 20, the smoothing capacitor 6 connected between the positive-side power line 74p and the negative-side power line 74n and the voltage sensor 11a for detecting the output voltage Vo of the smoothing capacitor 6 are omitted. Further, in FIG. 20, the filter 90 disposed between the AC input terminals 55r, 55s, and 55t, and the converter 91 and including the filter reactor 8 and the filter capacitor 9 is omitted. The first power conversion device 50 of Embodiment 5 shown in FIG. 20 is for an example of supplying three-phase AC power to a motor 51 being an AC motor, and the second power conversion device 50 of Embodiment 5 shown in FIG. 23 is for an example of supplying DC power to the motor 51 being a DC motor.

The inverter 92 is a bridge inverter circuit including, for example, six switching elements 3a to 3f. The switching elements 3a and 3b connected in series are an arm of a u-phase of the three-phase AC, the switching elements 3c and 3d connected in series are an arm of a v-phase of the three-phase AC, and the switching elements 3e and 3f connected in series are an arm of a w-phase of the three-phase AC. An AC output terminal 66u is connected to the connection point of the switching elements 3a and 3b, an AC output terminal 66v is connected to the connection point of the switching elements 3c and 3d, and an AC output terminal 66w is connected to the connection point of the switching elements 3e and 3f. The collectors of the switching elements 3a, 3c, and 3e are connected to the positive-side DC input terminal 65p, and the emitters of the switching elements 3b, 3d, and 3f are connected to the negative-side DC input terminals 65n. The inverter 92 outputs three-phase AC power from the AC terminals 66u, 66v, and 66w through output terminals 56a, 56b, and 56c of the power conversion device 50. Input terminals 67a, 67b, and 67c of the refrigerant circuit 110 are connected to the output terminals 56a, 56b, and 56c of the power conversion device 50 by power lines 72u, 72v, and 72w. Note that the reference signs for the power lines connecting the AC output terminals 66u, 66v, and 66w of the inverter 92 and the output terminals 56a, 56b, and 56c of the power conversion device 50 are also denoted by 72u, 72v, and 72w. The reference signs for the power lines connected to the input terminals 67a, 67b, and 67c of the refrigerant circuit 110 are collectively denoted by a reference numeral 72, and 72u, 72v, and 72w are used for distinction.

A control signal s1a is input to the gate of the switching element 3a via a control terminal 59a, and a control signal s1b is input to the gate of the switching elements 3b via a control terminal 59b. Similarly, a control signal s1c is input to the gate of the switching element 3c via a control terminal 59c, and a control signal s1d is input to the gate of the switching element 3d via a control terminal 59d. A control signal s1e is input to the gate of the switching elements 3e via a control terminals 59e, and a control signal s1f is input to the gate of the switching elements 3f via a control terminal 59f. A reference numeral 59 is collectively used for the control terminals of the inverter 92, and 59a to 59f are used for distinction. The reference signs for the control signals input to the inverter 92 are collectively referred to as sig1b, and are referred to as s1a to s1f for distinction.

The control terminal 58 of the converter 91 receives a control signal sigla output from a drive circuit 29a on the basis of the gate signal command G* output from the controller 10. The control terminal 59 of the inverter 92 receives a control signal sig1b output from a drive circuit 29b on the basis of a gate signal command Gi* output from the controller 10. The drive circuit 29a and the control signal sigla are the drive circuit 29 and the control signal sig1 of the power conversion device 50 of Embodiment 1 to Embodiment 4. The control signal sig1b is a signal for controlling the ON state and the OFF state of the switching elements 3a to 3f by, for example, PWM control. The drive circuit 29b outputs the control signal sig1b whose voltage value is changed on the basis of the gate signal command Gi* output from the controller 10. The gate signal command Gi* is generated for each of the switching elements 3a to 3f. As the gate signal command Gi*, a gate signal command for performing normal PWM control can be used.

An air conditioner, which is an example of a refrigeration cycle apparatus 120, is connected by a refrigerant pipe 108 in the order of a compressor 101, a four-way valve 102, an outdoor heat exchanger 103, an expansion device 104, an indoor heat exchanger 105, the four-way valve 102, and the compressor 101 to form the refrigeration cycle, that is, the refrigerant circuit 110. That is, in the refrigerant circuit 110, the compressor 101, a condenser (the outdoor heat exchanger 103 or the indoor heat exchanger 105), the expansion device 104, and an evaporator (the indoor heat exchanger 105 or the outdoor heat exchanger 103) are connected in a loop by the refrigerant pipe. In the refrigerant circuit 110, the indoor heat exchanger 105 is an indoor part 107, and the compressor 101, the four-way valve 102, the outdoor heat exchanger 103, and the expansion device 104 are an outdoor part 106. An indoor unit of the air conditioner includes the indoor heat exchanger 105 of the indoor part 107. An outdoor unit of the air conditioner includes the power conversion device 50, and the compressor 101, the four-way valve 102, the outdoor heat exchanger 103, and the expansion device 104 of the outdoor part 106. The compressor 101 includes the motor 51 and compression components 101a. The motor 51 is supplied with electric power from the power conversion device 50 and is rotationally driven. The power conversion device 50 supplies electric power to the motor 51 to rotationally drive the motor 51. The motor 51 is connected to the compression components 101a, and the motor 51 and the compression components 101a constitute the compressor 101 that compresses the refrigerant.

Next, the operation of the air conditioner will be described by taking a cooling operation as an example. Note that, when the cooling operation is performed, it is assumed that the four-way valve 102 switches the flow path in advance such that the refrigerant discharged from the compressor 101 is directed to the outdoor heat exchanger 103 and the refrigerant flowing out from the indoor heat exchanger 105 is directed to the compressor 101.

The motor 51 of the compressor 101 is rotationally driven by the power conversion device 50, whereby the compression components 101a of the compressor 101 connected to the motor 51 compress the refrigerant, and the compressor 101 discharge a high-temperature and high-pressure refrigerant. The high-temperature and high-pressure refrigerant discharged from the compressor 101 flows into the outdoor heat exchanger 103 via the four-way valve 102, and exchanges heat with the outside air in the outdoor heat exchanger 103 to radiate heat. The refrigerant flowing out of the outdoor heat exchanger 103 is expanded and decompressed by the expansion device 104 to become a low-temperature and low-pressure gas-liquid two-phase refrigerant, and flows into the indoor heat exchanger 105. The refrigerant that has flowed into the indoor heat exchanger 105 exchanges heat with the air in the space to be air-conditioned, evaporates, becomes a low-temperature and low-pressure gas refrigerant, and flows out of the indoor heat exchanger 105. The gas refrigerant flowing out of the indoor heat exchanger 105 is sucked into the compressor 101 via the four-way valve 102 and compressed again. The above operation is repeated. When the air conditioner performs the cooling operation, the outdoor heat exchanger 103 functions as the condenser, and the indoor heat exchanger 105 functions as the evaporator. When the air conditioner performs the heating operation, the outdoor heat exchanger 103 functions as the evaporator and the indoor heat exchanger 105 functions as the condenser, which is the reverse of the cooling operation.

Note that, although FIG. 20 shows an example in which the power conversion device 50 in which the inverter 92 is added to the power conversion device 50 of Embodiment 1 to Embodiment 4 is applied to the power conversion device that supplies power to the compressor 101 of the air conditioner as an example of the refrigeration cycle apparatus 120, this is not a limitation. When the motor 51 of the compressor 101 is a DC motor, as shown in FIG. 21, the power conversion device 50 of Embodiment 1 to Embodiment 4 can be applied to a power conversion device that supplies electric power to the compressor 101 of the refrigeration cycle apparatus 120. The power conversion device 50 shown in FIG. 23 outputs DC power outputted from the DC output terminal 64p and the DC output termina 64n of the converter 91 to the refrigerant circuit 110 via the output terminals 56a and 56b. When the motor 51 of the compressor 101 in the refrigerant circuit 110 is a DC motor, the refrigerant circuit 110 has two input terminals 67a and 67b. The input terminals 67a and 67b of the refrigerant circuit 110 are connected to output terminals 56a and 56b of the power conversion device 50 by the positive-side power line 74p and the negative-side power line 74n, respectively. Note that the power lines connecting the DC output terminals 64p and 64n of the converter 91 and the output terminals 56a and 56b of the power conversion device 50 are referred to as the positive-side power line 74p and the negative-side power line 74n. The smoothing capacitor 6 is connected between the positive-side power line 74p and the negative-side power line 74n. Note that, in FIG. 23, the voltage sensor 11a for detecting the output voltage Vo being the voltage of the smoothing capacitor 6 is omitted. In addition, it is needless to say that the refrigeration cycle apparatus 120 can be applied to a heat pump device, a refrigeration device, and other refrigeration cycle apparatuses in general, in addition to the air conditioner.

As described above, the refrigeration cycle apparatus 120 of Embodiment 5 includes the refrigerant circuit 110 in which the compressor 101, the condenser (the outdoor heat exchanger 103 or the indoor heat exchanger 105), the expansion device 104, and the evaporator (the indoor heat exchanger 105 or the outdoor heat exchanger 103) are connected in a loop by the refrigerant pipe 108, and the power conversion device 50 that drive the compressor 101 by supplying electric power to the compressor. The power conversion device 50 includes the rectifier circuit 2 that converts the input voltages (interphase voltage Vac) of the three-phase AC input from the AC input terminals 55r, 55s, and 55t into the DC voltage, the converter 91 that outputs the output voltage Vo set to the set voltage value, from the DC voltage output from the rectifier circuit 2, the smoothing capacitor 6 connected between the positive-side converter output terminal (DC output terminal 64p) and the negative-side converter output terminal (DC output terminal 64n) of the converter 91 from which the output voltage Vo is output, the filter 90 disposed between the AC input terminals 55r, 55s, and 55t, and the converter 91 and including the filter reactor 8 and the filter capacitor 9, and the controller 10 that controls the converter 91. In addition, the power conversion device 50 may include the inverter 92 that converts the DC output voltage Vo output from the converter 91 into the AC voltage and is controlled by the controller 10. The filter reactor 8 is disposed closer to the AC input terminals 55r, 55s, and 55t than the filter capacitor 9. In the refrigeration cycle apparatus 120 of Embodiment 5, with this configuration, the filter 90 including the filter reactor 8 and the filter capacitor 9 is disposed between the AC input terminals 55r, 55s, and 55t, and the converter 91, and the filter reactor 8 is disposed closer to the AC input terminals 55r, 55s, and 55t than the filter capacitor 9 in the power conversion device 50. Therefore, the carrier ripple current can be reduced, and the outflow of the carrier ripple current to the power supply can be reduced.

Note that, although various exemplary embodiments and examples are described in the present disclosure, various features, aspects, and functions described in one or more embodiments are not inherent in a particular embodiment and can be applicable alone or in their various combinations to each embodiment. Accordingly, countless variations that are not illustrated are envisaged within the scope of the art disclosed in the disclosure. For example, the case where at least one component is modified, added or omitted, and the case where at least one component is extracted and combined with a component in another embodiment are included.

Although the preferred embodiments and the like have been described in detail above, the above-described embodiments and the like is not a limitation, and various modifications and substitutions can be made to the above-described embodiments and the like without departing from the scope described in the claims.

Hereinafter, various aspects of the present disclosure will be collectively described as supplementary notes.

### Supplementary Note 1

The power conversion device includes the rectifier circuit to convert an input voltage of the three-phase AC input from the AC input terminals into a DC voltage, the converter to output an output voltage set to a set voltage value from the DC voltage output from the rectifier circuit, the smoothing capacitor connected between the positive-side converter output terminal and the negative-side converter output terminal of the converter from which the output voltage is output, the filter disposed between the AC input terminals and the converter and including the filter capacitor, and the controller to control the converter. The converter includes the switching element that is controlled with PWM by a control signal generated on the basis of the carrier wave and the on-duty command. The controller designates any one of the voltage of the filter, the current of the filter, the ripple component in the voltage of the filter, and the ripple component in the current of the filter as the filter focusing target and generates the on-duty command for reducing a difference between the detection value of the filter focusing target and the target value of the filter focusing target.

### Supplementary Note 2

The power conversion device according to Supplementary Note 1, wherein the filter incudes the filter reactor, and the filter reactor is connected between the positive-side rectifier circuit output terminal of the rectifier circuit and one end of the filter capacitor connected to the positive-side converter input terminal of the converter.

### Supplementary Note 3

The power conversion device according to Supplementary Note 1, wherein the filter incudes the filter reactor, and the filter reactor is connected between the AC input terminal and the rectifier circuit input terminal of the rectifier circuit.

### Supplementary Note 4

The power conversion device according to Supplementary Note 3, wherein the filter reactor constitutes the common mode choke coil.

### Supplementary Note 5

The power conversion device according to any one of

Supplementary Notes 1 to 4, wherein the controller includes the first system control unit to generate the first system command for reducing a difference between the detection value of the voltage of the smoothing capacitor and the target value of the voltage of the smoothing capacitor, the second system control unit to generate the second system command for reducing a difference between the detection value of the filter focusing target and the target value of the filter focusing target, and the on-duty command generation unit to generate the on-duty command based on the first system command and the second system command.

### Supplementary Note 6

The power conversion device according to Supplementary Note 5, wherein the filter focusing target is the voltage of the filter capacitor in the filter, the target value of the filter focusing target is the command value of the voltage of the filter capacitor, and the controller includes the phase voltage calculation unit to calculate phase voltages of the three phases of the three-phase AC from the interphase voltages that are voltages between any two of the three AC input terminals to which the three-phase AC is input, and the filter voltage command generation unit to generate the phase voltage deviation obtained by subtracting the minimum phase voltage from the maximum phase voltage as the command value of the voltage of the filter capacitor, when the maximum phase voltage is a phase voltage that is the highest among the phase voltages of the three phases, and the minimum phase voltage is a phase voltage that is the lowest among the phase voltages of the three phases.

### Supplementary Note 7

The power conversion device according to Supplementary Note 5, wherein the filter focusing target is the input current input to the filter, and the target value of the filter focusing target is the command value of the input current.

### Supplementary Note 8

The power conversion device according to Supplementary Note 5, wherein the filter focusing target is the ripple component of the filter capacitor voltage being the voltage of the filter capacitor in the filter, the target value of the filter focusing target is the command value of the ripple component of the filter capacitor voltage, and the controller includes the subtractor to subtract the ripple component of the filter capacitor voltage from the command value of the ripple component of the filter capacitor voltage, and the command value of the ripple component of the filter capacitor voltage is set to zero.

### Supplementary Note 9

The power conversion device according to Supplementary Note 5, wherein the filter focusing target is the ripple component of the input current input into the filter, the target value of the filter focusing target is the command value of the ripple component of the input current, and the controller includes the subtractor to subtract the ripple component of the input current from the command value of the ripple component of the input current, and the command value of the ripple component of the input current is set to zero.

### Supplementary Note 10

The power conversion device according to any one of Supplementary Notes 5 to 9, wherein the first system control unit includes one or more of the proportional output unit that performs proportional control, the integrator that performs integral control, and the differentiator that performs differential control.

### Supplementary Note 11

The power conversion device according to any one of Supplementary Notes 5 to 10, wherein the second system control unit includes one or more of the proportional output unit that performs proportional control, the integrator that performs integral control, and the differentiator that performs differential control.

### Supplementary Note 12

The power conversion device according to any one of Supplementary Notes 5 to 9, wherein the first system control unit includes one or more of the proportional output unit that performs proportional control, the integrator that performs integral control, and the differentiator that performs differential control, the second system control unit includes the proportional output unit, and the on-duty command generation unit includes one or more of the proportional output unit, the integrator, and the differentiator.

### Supplementary Note 13

The power conversion device according to Supplementary Note 5 or 6, wherein the filter focusing target is the voltage of the filter capacitor in the filter, a frequency for controlling the converter is the control frequency, a number obtained by dividing the control frequency by the frequency of the three-phase AC is the division number, and the controller includes, in the second system control unit or the on-duty command generation unit, the phase change feedback control unit to perform proportional processing and integral processing on the input data input from the first terminal and output the output data changed by the predetermined set phase from the second terminal. The phase change feedback control unit includes the same number of integrators as the division number, the selector that selects an integrator to which data is input, the selector that selects an integrator that outputs data having a phase different from the input data by the set phase, and the proportional output unit on the data path between the first terminal and the second terminal.

### Supplementary Note 14

The power conversion device according to Supplementary Note 5 or 8, wherein the filter focusing target is the ripple component of the voltage of the filter capacitor in the filter, a frequency for controlling the converter is the control frequency, a number obtained by dividing the control frequency by the frequency of the three-phase AC is the division number, and the controller includes, in the second system control unit or the on-duty command generation unit, the phase change feedback control unit to perform proportional processing and integral processing on the input data input from the first terminal and output the output data changed by the predetermined set phase from the second terminal. The phase change feedback control unit includes the same number of integrators as the division number, the selector that selects an integrator to which data is input, the selector that selects an integrator that outputs data having a phase different from the input data by the set phase, and the proportional output unit on the data path between the first terminal and the second terminal.

### Supplementary Note 15

The power conversion device according to any one of Supplementary Notes 5 to 11, 13, and 14, wherein the controller, in the first system control unit, includes the feedback control unit that generates the on-duty command such that the input current of the three-phase AC becomes a rectangular wave current.

### Supplementary Note 16

The power conversion device according to Supplementary Note 12, wherein the controller, in the on-duty command generation unit, includes the feedback control unit that generates the on-duty command such that the input current of the three-phase AC becomes a rectangular wave current.

### Supplementary Note 17

The power conversion device according to any one of Supplementary Notes 1 to 16, wherein the filter includes the filter reactor, and the resonant frequency depending on the filter capacitor and the filter reactor in the filter is set to be equal to or higher than a frequency 18 times the frequency of the three-phase AC and equal to or lower than half of the frequency of the carrier wave.

### Supplementary Note 18

The power conversion device according to any one of Supplementary Notes 1 to 17, wherein the converter is any one of the step-down converter, the step-up converter, and the step-up/step-down converter.

### Supplementary Note 19

The power conversion device according to any one of Supplementary Notes 1 to 18, further includes the inverter to convert the output voltage of a DC output from the converter into an AC voltage. The controller controls the inverter.

### Supplementary Note 20

The refrigeration cycle apparatus includes the refrigerant circuit in which the compressor, the condenser, the expansion device, and the evaporator are connected in a loop by the refrigerant pipe, and the power conversion device according to any one of Supplementary Notes 1 to 19 that drives the compressor by supplying electric power to the compressor.

What is claimed is:

1. A power conversion device comprising:
a rectifier circuit to convert an input voltage of a three-phase AC input from AC input terminals into a DC voltage;
a converter to output an output voltage set to a set voltage value from the DC voltage output from the rectifier circuit;
a smoothing capacitor connected between a positive-side converter output terminal and a negative-side converter output terminal of the converter from which the output voltage is output;
a filter disposed between the AC input terminals and the converter and including a filter capacitor; and
a controller to control the converter, wherein
the converter includes a switching element that is controlled with PWM by a control signal generated on a basis of a carrier wave and an on-duty command, and
the controller designates any one of a voltage of the filter, a current of the filter, a ripple component in the voltage of the filter, and a ripple component in the current of the filter as a filter focusing target and generates the on-duty command for reducing a difference between a detection value of the filter focusing target and a target value of the filter focusing target.

2. The power conversion device according to claim 1, wherein the filter incudes a filter reactor, and the filter reactor is connected between a positive-side rectifier circuit output terminal of the rectifier circuit and one end of the filter capacitor connected to a positive-side converter input terminal of the converter.

3. The power conversion device according to claim 1, wherein the filter incudes a filter reactor, and the filter reactor is connected between the AC input terminal and a rectifier circuit input terminal of the rectifier circuit.

4. The power conversion device according to claim 3, wherein the filter reactor constitutes a common mode choke coil.

5. The power conversion device according to claim 1, wherein the controller includes:
a first system control unit to generate a first system command for reducing a difference between a detection value of a voltage of the smoothing capacitor and a target value of the voltage of the smoothing capacitor;
a second system control unit to generate a second system command for reducing a difference between the detection value of the filter focusing target and the target value of the filter focusing target; and
an on-duty command generation unit to generate the on-duty command based on the first system command and the second system command.

6. The power conversion device according to claim 5, wherein the filter focusing target is a voltage of the filter capacitor in the filter, the target value of the filter focusing target is a command value of the voltage of the filter capacitor, and the controller includes:
a phase voltage calculation unit to calculate phase voltages of three phases of the three-phase AC from interphase voltages that are voltages between any two of the three AC input terminals to which the three-phase AC is input; and
a filter voltage command generation unit to generate a phase voltage deviation obtained by subtracting a minimum phase voltage from a maximum phase voltage as the command value of the voltage of the filter capacitor, when the maximum phase voltage is a phase voltage that is the highest among the phase voltages of the three phases, and the minimum phase voltage is a phase voltage that is the lowest among the phase voltages of the three phases.

7. The power conversion device according to claim 5, wherein the filter focusing target is an input current input to the filter, and the target value of the filter focusing target is a command value of the input current.

8. The power conversion device according to claim 5, wherein the filter focusing target is a ripple component of a filter capacitor voltage being a voltage of the filter capacitor in the filter, the target value of the filter focusing target is a command value of the ripple component of the filter capacitor voltage, the controller includes a subtractor to subtract the ripple component of the filter capacitor voltage from the command value of the ripple component of the filter capacitor voltage, and the command value of the ripple component of the filter capacitor voltage is set to zero.

9. The power conversion device according to claim 5, wherein the filter focusing target is a ripple component of an input current input into the filter, the target value of the filter focusing target is a command value of the ripple component of the input current, the controller includes a subtractor to subtract the ripple component of the input current from the command value of the ripple component of the input current, and the command value of the ripple component of the input current is set to zero.

10. The power conversion device according to claim 5, wherein the first system control unit includes one or more of a proportional output unit that performs proportional control, an integrator that performs integral control, and a differentiator that performs differential control.

11. The power conversion device according to claim 5, wherein the second system control unit includes one or more of a proportional output unit that performs proportional control, an integrator that performs integral control, and a differentiator that performs differential control.

12. The power conversion device according to claim 5, wherein the first system control unit includes one or more of a proportional output unit that performs proportional control, an integrator that performs integral control, and a differentiator that performs differential control, the second system control unit includes a proportional output unit, and the on-duty command generation unit includes one or more of a proportional output unit, an integrator, and a differentiator.

13. The power conversion device according to claim 5, wherein the filter focusing target is a voltage of the filter capacitor in the filter, a frequency for controlling the converter is a control frequency, a number obtained by dividing the control frequency by a frequency of the three-phase AC is a division number, and the controller includes, in the second system control unit or the on-duty command generation unit, a phase change feedback control unit to perform proportional processing and integral processing on input data input from a first terminal and output output data changed by a predetermined set phase from a second terminal, wherein
the phase change feedback control unit includes:
the same number of integrators as the division number;
a selector that selects an integrator to which data is input;
a selector that selects an integrator that outputs data having a phase different from the input data by the set phase; and
a proportional output unit on a data path between the first terminal and the second terminal.

14. The power conversion device according to claim 5, wherein the filter focusing target is a ripple component of a voltage of the filter capacitor in the filter, a frequency for controlling the converter is a control frequency, a number obtained by dividing the control frequency by a frequency of the three-phase AC is a division number, and the controller includes, in the second system control unit or the on-duty command generation unit, a phase change feedback control unit to perform proportional processing and integral processing on input data input from a first terminal and output output data changed by a predetermined set phase from a second terminal, wherein
the phase change feedback control unit includes:
the same number of integrators as the division number;
a selector that selects an integrator to which data is input;
a selector that selects an integrator that outputs data having a phase different from the input data by the set phase; and
a proportional output unit on a data path between the first terminal and the second terminal.

15. The power conversion device according to claim 5, wherein the controller, in the first system control unit, includes a feedback control unit that generates the on-duty command such that an input current of the three-phase AC becomes a rectangular wave current.

16. The power conversion device according to claim 12, wherein the controller, in the on-duty command generation unit, includes a feedback control unit that generates the on-duty command such that an input current of the three-phase AC becomes a rectangular wave current.

17. The power conversion device according to claim 1, wherein the filter includes a filter reactor, and a resonant frequency depending on the filter capacitor and the filter reactor in the filter is set to be equal to or higher than a frequency 18 times a frequency of the three-phase AC and equal to or lower than half of a frequency of the carrier wave.

18. The power conversion device according to claim 1, wherein the converter is any one of a step-down converter, a step-up converter, and a step-up/step-down converter.

19. The power conversion device according to claim 1, further comprising:
an inverter to convert the output voltage of a DC output from the converter into an AC voltage, wherein the controller controls the inverter.

20. A refrigeration cycle apparatus comprising:
a refrigerant circuit in which a compressor, a condenser, an expansion device, and an evaporator are connected in a loop by a refrigerant pipe; and
the power conversion device according to claim 1 that drives the compressor by supplying electric power to the compressor.
